(19) United States
(12) Patent Application Publication
(10) Pub. No.: US 2026/0352442 A1
(43) Pub. Date: Nov. 5, 2026

(54) METHOD FOR CARRYING OUT USER AUTHENTICATION IN QUANTUM COMMUNICATION SYSTEM, AND DEVICE THEREFOR

(71) Applicant: LG ELECTRONICS INC., Seoul (KR)

(72) Inventors: Byungkyu AHN, Seoul (KR); Sangrim LEE, Seoul (KR); Hojae LEE, Seoul (KR); JaYeong KIM, Seoul (KR)

(73) Assignee: LG ELECTRONICS INC., Seoul (KR)

(21) Appl. No.: 19/101,550

(22) PCT Filed: Aug. 8, 2022
(86) PCT No.: PCT/KR2022/011803

§ 371 Date: Feb. 5, 2025

(51) Int. Cl. H04L 9/08; G06N 10/70; H04L 9/32

(52) U.S. Cl. CPC H04L 9/0816; H04L 9/32; G06N 10/70

(57) ABSTRACT

A method of performing user authentication in a quantum communication system is provided. More specifically, the method includes transmitting, to a receiving terminal, quantum bit error rate (QBER) estimation information generated based on a checking sequence for QBER estimation for determining whether there is an eavesdropping on a quantum channel; performing the QBER estimation with the receiving terminal based on the QBER estimation information; and performing the authentication with the receiving terminal by reusing the checking sequence, based on a result of the QBER estimation. The authentication is performed based on (i) the reused checking sequence and (ii) a pre-shared symmetric key between the transmitting terminal and the receiving terminal.

### TECHNICAL FIELD

The present disclosure relates to a quantum communication system, and more particularly to a method of performing user authentication in a quantum communication system and a device therefor.

### BACKGROUND ART

Wireless communication systems are widely deployed to provide various types of communication services, such as voice and data. In general, the wireless communication system is a multiple access system capable of supporting communication with multiple users by sharing available system resources (bandwidth, transmission power, etc.). Examples of the multiple access system include a Code Division Multiple Access (CDMA) system, a Frequency Division Multiple Access (FDMA) system, a Time Division Multiple Access (TDMA) system, a Space Division Multiple Access (SDMA) system, an Orthogonal Frequency Division Multiple Access (OFDMA) system, a Single Carrier Frequency Division Multiple Access (SC-FDMA) system, and an Interleave Division Multiple Access (IDMA) system. In addition, research is ongoing on quantum communication, which is a next-generation communication technology that can overcome the limitations of existing information and communication, such as security and ultra-fast computation, by applying quantum mechanical properties to the information and communication field. The quantum communication provides a means to generate, transmit, process, and store information in the form of a superposition of 0 and 1, unlike the existing communication which is based on binary bit information. In the existing communication technologies, wavelengths, amplitudes, or the like have been used for information transmission between a transmitting terminal and a receiving terminal, but in the quantum communication, a photon, which is the smallest unit of light, is used for the information transmission between the transmitting terminal and the receiving terminal.

### DISCLOSURE

### Technical Problem

An object of the present disclosure is to provide a method of performing user authentication in a quantum communication system and a device therefor.

Another object of the present disclosure is to provide a method of performing user authentication using information transmitted through a quantum channel in a quantum communication system and a device therefor.

Another object of the present disclosure is to provide a method of performing user authentication using information used for quantum bit error rate (QBER) estimation in a quantum communication system and a device therefor.

Another object of the present disclosure is to provide a method and a device for updating a symmetric key for user authentication pre-shared between a transmitting terminal and a receiving terminal in a quantum communication system.

The technical objects to be achieved by the present disclosure are not limited to those that have been described hereinabove merely by way of example, and other technical objects that are not mentioned can be clearly understood by those skilled in the art, to which the present disclosure pertains, from the following descriptions.

### Technical Solution

The present disclosure provides a method of performing user authentication in a quantum communication system and a device therefor.

More specifically, a method of performing, by a transmitting terminal, an authentication in a quantum communication system according to the present disclosure comprises transmitting, to a receiving terminal, quantum bit error rate (QBER) estimation information generated based on a checking sequence for QBER estimation for determining whether there is an eavesdropping on a quantum channel; performing the QBER estimation with the receiving terminal based on the QBER estimation information; and performing the authentication with the receiving terminal by reusing the checking sequence, based on a result of the QBER estimation. The authentication is performed based on (i) the reused checking sequence and (ii) a pre-shared symmetric key between the transmitting terminal and the receiving terminal.

The method may further comprise transmitting, to the receiving terminal, error correction information for correcting an error between (i) a bit value of the checking sequence generated by the transmitting terminal and (ii) a bit value of a receiving terminal checking sequence acquired by measuring the QBER estimation information by the receiving terminal.

The error correction information may include (i) information for the bit value of the checking sequence and (ii) information for a basis used for a polarization coding for a bit at a specific location in a bit string of the checking sequence.

Based on (a) (i) the basis used for the polarization coding for the bit at the specific location in the bit string of the checking sequence at the transmitting terminal and (ii) a basis at the receiving terminal used for measuring the QBER estimation information corresponding to the specific location in the bit string of the checking sequence at the transmitting terminal being the same, and (b) (i) a bit value of the bit at the specific location and (ii) a measurement value of the QBER estimation information corresponding to the specific location being different; the measurement value at the receiving terminal of the QBER estimation information corresponding to the specific location may be corrected to the same value as the bit value of the bit at the specific location based on the error correction information.

An authentication message for the authentication may be generated based on (i) the reused checking sequence and (ii) the pre-shared symmetric key.

The pre-shared symmetric key may be used to determine a location of bits used to generate the authentication message in a bit string of the reused checking sequence.

A length of a bit string of the pre-shared symmetric key and a length of a bit string constituting the reused checking sequence may be the same.

At least one bit in the bit string of the reused checking sequence which is at a location corresponding to a location of at least one bit with a specific bit value in the bit string of the pre-shared symmetric key may be the authentication message.

Based on a bit value at a first location of the bit string of the pre-shared symmetric key, bit values of odd positions or bit values of even positions in the bit string of the reused checking sequence may be used to generate the authentication message.

The authentication message may be generated based on a XOR operation on (i) the pre-shared symmetric key and (ii) bit values of odd positions or bit values of even positions in a bit string of a checking sequence.

Based on the bit values of the odd positions in the bit string of the checking sequence being used to generate the authentication message, bit values of odd positions of the pre-shared symmetric key may be used for the XOR operation. Based on the bit values of the even positions in the bit string of the checking sequence being used to generate the authentication message, bit values of even positions of the pre-shared symmetric key may be used for the XOR operation.

The pre-shared symmetric key may be used to select a hash function for generating the authentication message.

The reused checking sequence may be used as an input of the hash function mapped to a bit value of the pre-shared symmetric key, and an output value of the hash function mapped to the bit value of the pre-shared symmetric key may be the authentication message.

The method may further comprise transmitting, to the receiving terminal, message information on the quantum channel based on a result of the authentication; and updating the pre-shared symmetric key based on (i) the message information and (ii) the pre-shared symmetric key.

The pre-shared symmetric key may be updated based on an XOR operation on (i) the message information and (ii) the pre-shared symmetric key.

A transmitting terminal performing an authentication in a quantum communication system according to the present disclosure comprises a transmitter transmitting a radio signal; a receiver receiving the radio signal; at least one processor; and at least one computer memory operably connectable to the at least one processor and storing instructions performing operations based on being executed by the at least one processor, wherein the operations comprise transmitting, to a receiving terminal, quantum bit error rate (QBER) estimation information generated based on a checking sequence for QBER estimation for determining whether there is an eavesdropping on a quantum channel; performing the QBER estimation with the receiving terminal based on the QBER estimation information; and performing the authentication with the receiving terminal by reusing the checking sequence, based on a result of the QBER estimation. The authentication is performed based on (i) the reused checking sequence and (ii) a pre-shared symmetric key between the transmitting terminal and the receiving terminal.

A method of performing, by a receiving terminal, an authentication in a quantum communication system according to the present disclosure comprises receiving, from a transmitting terminal, quantum bit error rate (QBER) estimation information generated based on a checking sequence for QBER estimation for determining whether there is an eavesdropping on a quantum channel; performing the QBER estimation with the transmitting terminal based on the QBER estimation information; and performing the authentication with the transmitting terminal by reusing the checking sequence, based on a result of the QBER estimation. The authentication is performed based on (i) the reused checking sequence and (ii) a pre-shared symmetric key between the transmitting terminal and the receiving terminal.

A receiving terminal performing an authentication in a quantum communication system according to the present disclosure comprises a transmitter transmitting a radio signal; a receiver receiving the radio signal; at least one processor; and at least one computer memory operably connectable to the at least one processor and storing instructions performing operations based on being executed by the at least one processor, wherein the operations comprise receiving, from a transmitting terminal, quantum bit error rate (QBER) estimation information generated based on a checking sequence for QBER estimation for determining whether there is an eavesdropping on a quantum channel; performing the QBER estimation with the transmitting terminal based on the QBER estimation information; and performing the authentication with the transmitting terminal by reusing the checking sequence, based on a result of the QBER estimation. The authentication is performed based on (i) the reused checking sequence and (ii) a pre-shared symmetric key between the transmitting terminal and the receiving terminal.

In a non-transitory computer readable medium (CRM) storing one or more instructions according to the present disclosure, the one or more instructions executable by one or more processors control a transmitting terminal to transmit, to a receiving terminal, quantum bit error rate (QBER) estimation information generated based on a checking sequence for QBER estimation for determining whether there is an eavesdropping on a quantum channel; perform the QBER estimation with the receiving terminal based on the QBER estimation information; and perform the authentication with the receiving terminal by reusing the checking sequence, based on a result of the QBER estimation. The authentication is performed based on (i) the reused checking sequence and (ii) a pre-shared symmetric key between the transmitting terminal and the receiving terminal.

In a device according to the present disclosure including one or more memories and one or more processors operably connected to the one or more memories, the one or more processors control the device to transmit, to a receiving terminal, quantum bit error rate (QBER) estimation information generated based on a checking sequence for QBER estimation for determining whether there is an eavesdropping on a quantum channel; perform the QBER estimation with the receiving terminal based on the QBER estimation information; and perform the authentication with the receiving terminal by reusing the checking sequence, based on a result of the QBER estimation. The authentication is performed based on (i) the reused checking sequence and (ii) a pre-shared symmetric key between the transmitting terminal and the receiving terminal.

### Advantageous Effects

The present disclosure has an effect of performing user authentication in a quantum communication system.

The present disclosure has an effect of performing user authentication using information transmitted on a quantum channel in a quantum communication system.

The present disclosure has an effect of ensuring security without assuming that transmitting and receiving terminals of a classical channel and a quantum channel are identical. since user authentication is performed using information transmitted on the quantum channel in a quantum communication system.

The present disclosure has an effect of performing user authentication using information used for quantum bit error rate (QBER) estimation in a quantum communication system.

The present disclosure has an effect of performing user authentication without generating a separate authentication message for user authentication in a quantum communication system.

The present disclosure has an effect of saving communication resources because it does not generate a separate authentication message for user authentication in a quantum communication system.

The present disclosure has an effect of updating a symmetric key for pre-shared user authentication between a transmitting terminal and a receiving terminal in a quantum communication system.

The present disclosure has an effect of ensuring security because it can update a symmetric key for pre-shared user authentication between a transmitting terminal and a receiving terminal in a quantum communication system.

The present disclosure has an effect of increasing the efficiency of generating a secret key used for data encryption and decryption in a quantum key distribution system.

Effects that could be achieved with the present disclosure are not limited to those that have been described hereinabove merely by way of example, and other effects and advantages of the present disclosure will be more clearly understood from the following description by a person skilled in the art to which the present disclosure pertains.

### DESCRIPTION OF DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates an example of a communication system applicable to the present disclosure.

FIG. 2 illustrates an example of a wireless apparatus applicable to the present disclosure.

FIG. 3 illustrates a method of processing a transmitted signal applicable to the present disclosure.

FIG. 4 illustrates another example of a wireless device applicable to the present disclosure.

FIG. 5 illustrates an example of a hand-held device applicable to the present disclosure.

FIG. 6 illustrates physical channels applicable to the present disclosure and a signal transmission method using the same.

FIG. 7 illustrates the structure of a radio frame applicable to the present disclosure.

FIG. 8 illustrates a slot structure applicable to the present disclosure.

FIG. 9 illustrates an example of a communication structure providable in a 6G system applicable to the present disclosure.

FIG. 10 illustrates an example of a man-in-the-middle (MITM) attack that may occur in quantum communication.

FIG. 11 illustrates an example of a MAC-based authentication scheme.

FIG. 12 illustrates an example of an authentication scheme based on Wegman & Carter Authentication (WCA).

FIG. 13 illustrates a correlation between the number of hash functions and the probability of collision.

FIG. 14 illustrates an example of a method of updating a symmetric key in a quantum key distribution scheme.

FIG. 15 illustrates an example of a tag generation process in an existing authentication scheme.

FIG. 16 illustrates an example where user authentication is performed through a classical channel in quantum communication.

FIG. 17 illustrates an example of performing user authentication using QBER estimation information transmitted on a quantum channel in quantum communication.

FIG. 18 illustrates a method in which a pre-shared symmetric key is used to determine a location of authentication information.

FIG. 19 is a flowchart illustrating a user authentication process to which a method described in the present disclosure is applied.

FIG. 20 illustrates an example of performing a method in which a pre-shared symmetric key is used for an XOR operation with a message for MAC generation.

FIG. 21 is a flowchart illustrating a user authentication process to which a method described in the present disclosure is applied.

FIG. 22 illustrates a method in which a pre-shared symmetric key is used to select a hash function to be used for MAC generation among hash functions constituting a hash function set H used as a MAC algorithm

FIG. 23 is a flowchart illustrating a user authentication process to which a method described in the present disclosure is applied.

FIG. 24 illustrates a method of updating a pre-shared symmetric key.

FIG. 25 is a flowchart illustrating an example in which a user authentication method described in the present disclosure is performed by a transmitting terminal.

FIG. 26 is a flowchart illustrating an example in which a user authentication method described in the present disclosure is performed by a receiving terminal.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a Base Station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an Advanced Base Station (ABS), an access point, etc.

In the embodiments of the present disclosure, the term terminal may be replaced with a UE, a Mobile Station (MS), a Subscriber Station (SS), a Mobile Subscriber Station (MSS), a mobile terminal, an Advanced Mobile Station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an UpLink (UL). Likewise, the mobile station may serve as a receiver and the BS may serve as a transmitter, on a DownLink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

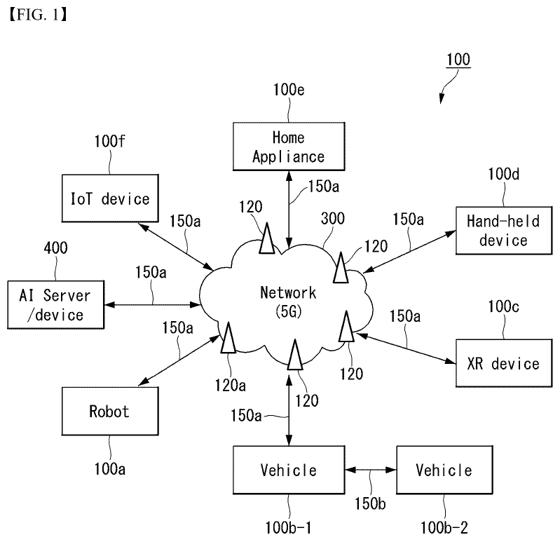

FIG. 1 illustrates an example of a communication system applicable to the present disclosure. Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

### Communication System Applicable to the Present Disclosure

FIG. 2 illustrates an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be connected with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be connected with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be connected with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be connected with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be connected with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be connected with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be connected with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be connected with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

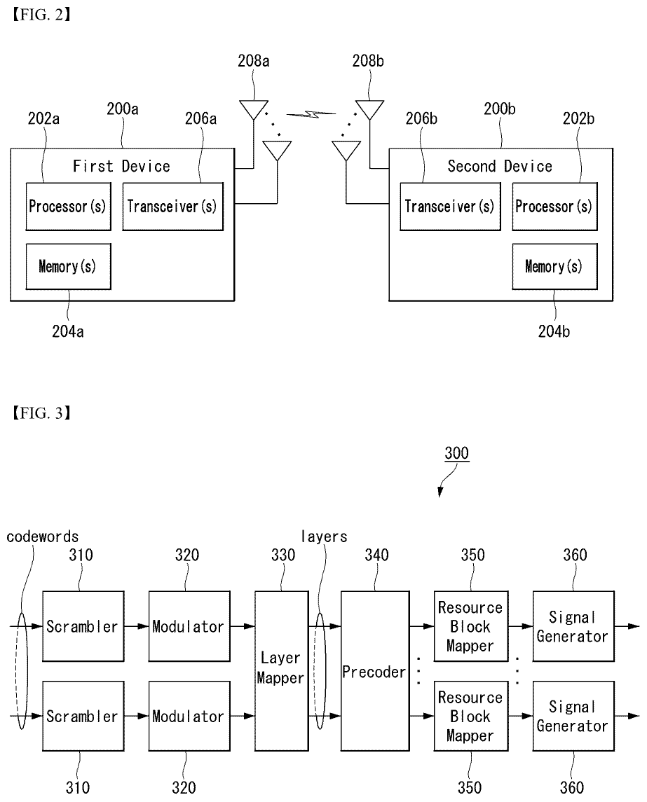

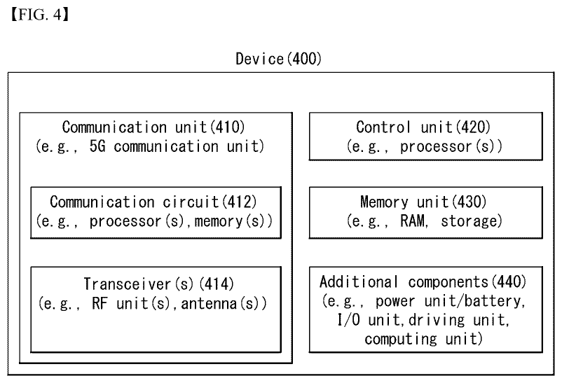

FIG. 3 illustrates a method of processing a transmitted signal applicable to the present disclosure. For example, the transmitted signal may be processed by a signal processing circuit. At this time, a signal processing circuit 300 may include a scrambler 310, a modulator 320, a layer mapper 330, a precoder 340, a resource mapper 350, and a signal generator 360. At this time, for example, the operation/function of FIG. 3 may be performed by the processors 202a and 202b and/or the transceiver 206a and 206b of FIG. 2. In addition, for example, the hardware element of FIG. 3 may be implemented in the processors 202a and 202b of FIG. 2 and/or the transceivers 206a and 206b of FIG. 2. For example, blocks 1010 to 1060 may be implemented in the processors 202a and 202b of FIG. 2. In addition, blocks 310 to 350 may be implemented in the processors 202a and 202b of FIG. 2 and a block 360 may be implemented in the transceivers 206a and 206b of FIG. 2, without being limited to the above-described embodiments.

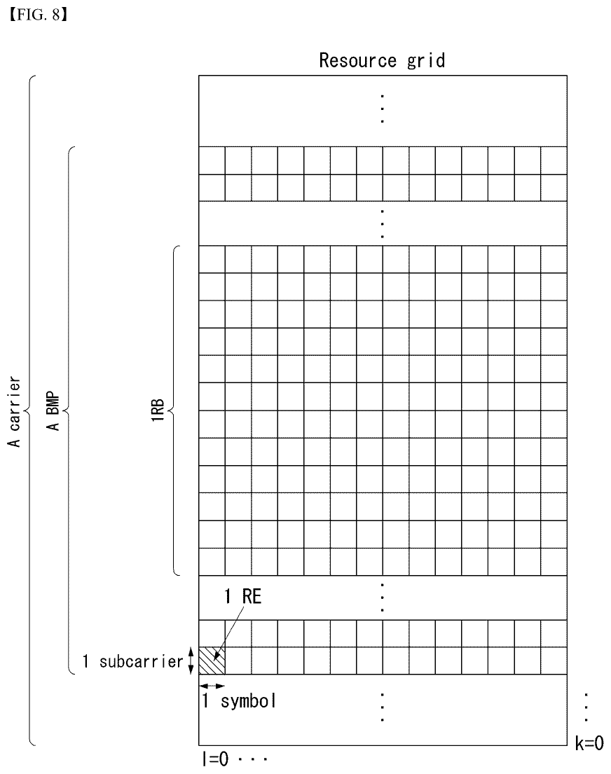

A codeword may be converted into a radio signal through the signal processing circuit 300 of FIG. 3. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH) of FIG. 6. Specifically, the codeword may be converted into a bit sequence scrambled by the scrambler 310. The scramble sequence used for scramble is generated based in an initial value and the initial value may include ID information of a wireless device, etc. The scrambled bit sequence may be modulated into a modulated symbol sequence by the modulator 320. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 330. Modulation symbols of each transport layer may be mapped to corresponding antenna port(s) by the precoder 340 (precoding). The output z of the precoder 340 may be obtained by multiplying the output y of the layer mapper 330 by an N*M precoding matrix W. Here, N may be the number of antenna ports and M may be the number of transport layers. Here, the precoder 340 may perform precoding after transform precoding (e.g., discrete Fourier transform (DFT)) for complex modulation symbols. In addition, the precoder 340 may perform precoding without performing transform precoding.

The resource mapper 350 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 360 may generate a radio signal from the mapped modulation symbols, and the generated radio signal may be transmitted to another device through each antenna. To this end, the signal generator 360 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 310 to 360 of FIG. 3. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### Structure of Wireless Device Applicable to the Present Disclosure

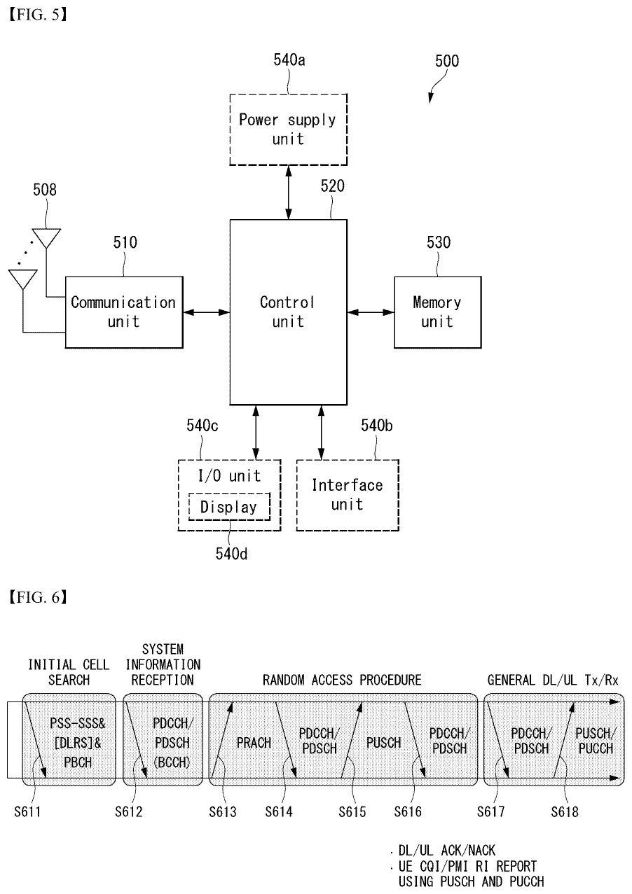

FIG. 4 illustrates another example of a wireless device applicable to the present disclosure.

Referring to FIG. 4, a wireless device 400 may correspond to the wireless devices 200a and 200b of FIG. 2 and include various elements, components, units/portions and/or modules. For example, the wireless device 300 may include a communication unit 410, a control unit (controller) 420, a memory unit (memory) 430 and additional components 440. The communication unit may include a communication circuit 412 and a transceiver(s) 414. For example, the communication circuit 412 may include one or more processors 202a and 202b and/or one or more memories 204a and 204b of FIG. 2. For example, the transceiver(s) 414 may include one or more transceivers 206a and 206b and/or one or more antennas 208a and 208b of FIG. 2. The control unit 420 may be electrically connected with the communication unit 410, the memory unit 430 and the additional components 440 to control overall operation of the wireless device. For example, the control unit 420 may control electrical/mechanical operation of the wireless device based on a program/code/instruction/information stored in the memory unit 430. In addition, the control unit 420 may transmit the information stored in the memory unit 430 to the outside (e.g., another communication device) through the wireless/wired interface using the communication unit 410 over a wireless/wired interface or store information received from the outside (e.g., another communication device) through the wireless/wired interface using the communication unit 410 in the memory unit 430.

The additional components 440 may be variously configured according to the types of the wireless devices. For example, the additional components 440 may include at least one of a power unit/battery, an input/output unit, a driving unit or a computing unit. Without being limited thereto, the wireless device 300 may be implemented in the form of the robot (FIG. 1, 100a), the vehicles (FIG. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, a MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 4, various elements, components, units/portions and/or modules in the wireless device 400 may be connected with each other through wired interfaces or at least some thereof may be wirelessly connected through the communication unit 410. For example, in the wireless device 400, the control unit 420 and the communication unit 410 may be connected by wire, and the control unit 420 and the first unit (e.g., 130 or 140) may be wirelessly connected through the communication unit 410. In addition, each element, component, unit/portion and/or module of the wireless device 400 may further include one or more elements. For example, the control unit 420 may be composed of a set of one or more processors. For example, the control unit 420 may be composed of a set of a communication control processor, an application processor, an electronic control unit (ECU), a graphic processing processor, a memory control processor, etc. In another example, the memory unit 430 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

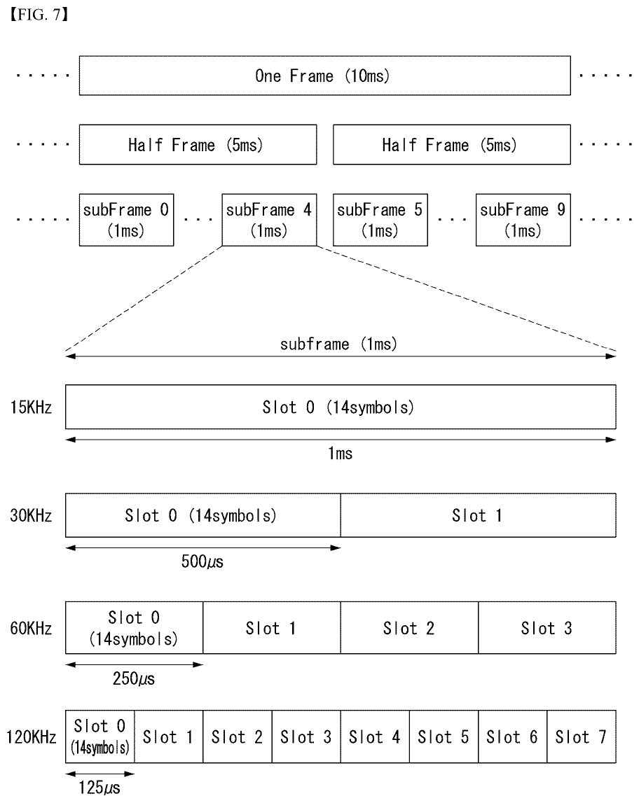

FIG. 5 illustrates an example of a hand-held device applicable to the present disclosure.

FIG. 5 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 5, the hand-held device 400 may include an antenna unit (antenna) 508, a communication unit (transceiver) 510, a control unit (controller) 520, a memory unit (memory) 530, a power supply unit (power supply) 540a, an interface unit (interface) 540b, and an input/output unit 540c. An antenna unit (antenna) 508 may be part of the communication unit 510. The blocks 510 to 530/540a to 540c may correspond to the blocks 410 to 430/440 of FIG. 4, respectively.

The communication unit 510 may transmit and receive signals (e.g., data, control signals, etc.) to and from other wireless devices or base stations. The control unit 520 may control the components of the hand-held device 500 to perform various operations. The control unit 520 may include an application processor (AP). The memory unit 530 may store data/parameters/program/code/instructions necessary to drive the hand-held device 400. In addition, the memory unit 530 may store input/output data/information, etc. The power supply unit 540a may supply power to the hand-held device 500 and include a wired/wireless charging circuit, a battery, etc. The interface unit 540b may support connection between the hand-held device 500 and another external device. The interface unit 540b may include various ports (e.g., an audio input/output port and a video input/output port) for connection with the external device. The input/output unit 540c may receive or output video information/signals, audio information/signals, data and/or user input information. The input/output unit 540c may include a camera, a microphone, a user input unit, a display 540d, a speaker and/or a haptic module.

For example, in case of data communication, the input/output unit 540c may acquire user input information/signal (e.g., touch, text, voice, image or video) from the user and store the user input information/signal in the memory unit 530. The communication unit 510 may convert the information/signal stored in the memory into a radio signal and transmit the converted radio signal to another wireless device directly or transmit the converted radio signal to a base station. In addition, the communication unit 510 may receive a radio signal from another wireless device or the base station and then restore the received radio signal into original information/signal. The restored information/signal may be stored in the memory unit 530 and then output through the input/output unit 540c in various forms (e.g., text, voice, image, video and haptic).

### Physical Channels and General Signal Transmission

In a radio access system, a UE receives information from a base station on a DL and transmits information to the base station on a UL. The information transmitted and received between the UE and the base station includes general data information and a variety of control information. There are many physical channels according to the types/usages of information transmitted and received between the base station and the UE.

FIG. 6 illustrates physical channels applicable to the present disclosure and a signal transmission method using the same.

The UE which is turned on again in a state of being turned off or has newly entered a cell performs initial cell search operation in step S611 such as acquisition of synchronization with a base station. Specifically, the UE performs synchronization with the base station, by receiving a Primary Synchronization Channel (P-SCH) and a Secondary Synchronization Channel (S-SCH) from the base station, and acquires information such as a cell Identifier (ID).

Thereafter, the UE may receive a physical broadcast channel (PBCH) signal from the base station and acquire intra-cell broadcast information. Meanwhile, the UE may receive a downlink reference signal (DL RS) in an initial cell search step and check a downlink channel state. The UE which has completed initial cell search may receive a physical downlink control channel (PDCCH) and a physical downlink control channel (PDSCH) according to physical downlink control channel information in step S612, thereby acquiring more detailed system information.

Thereafter, the UE may perform a random access procedure such as steps S613 to S616 in order to complete access to the base station. To this end, the UE may transmit a preamble through a physical random access channel (PRACH) (S613) and receive a random access response (RAR) to the preamble through a physical downlink control channel and a physical downlink shared channel corresponding thereto (S614). The UE may transmit a physical uplink shared channel (PUSCH) using scheduling information in the RAR (S615) and perform a contention resolution procedure such as reception of a physical downlink control channel signal and a physical downlink shared channel signal corresponding thereto (S616).

The UE, which has performed the above-described procedures, may perform reception of a physical downlink control channel signal and/or a physical downlink shared channel signal (S617) and transmission of a physical uplink shared channel (PUSCH) signal and/or a physical uplink control channel (PUCCH) signal (S618) as general uplink/downlink signal transmission procedures.

The control information transmitted from the UE to the base station is collectively referred to as uplink control information (UCI). The UCI includes hybrid automatic repeat and request acknowledgement/negative-ACK (HARQ-ACK/NACK), scheduling request (SR), channel quality indication (CQI), precoding matrix indication (PMI), rank indication (RI), beam indication (BI) information, etc. At this time, the UCI is generally periodically transmitted through a PUCCH, but may be transmitted through a PUSCH in some embodiments (e.g., when control information and traffic data are simultaneously transmitted). In addition, the UE may aperiodically transmit UCI through a PUSCH according to a request/instruction of a network.

FIG. 7 illustrates the structure of a radio frame applicable to the present disclosure.

UL and DL transmission based on an NR system may be based on the frame shown in FIG. 7. At this time, one radio frame has a length of 10 ms and may be defined as two 5-ms half-frames (HFs). One half-frame may be defined as five 1-ms subframes (SFs). One subframe may be divided into one or more slots and the number of slots in the subframe may depend on subscriber spacing (SCS). At this time, each slot may include 12 or 14 OFDM(A) symbols according to cyclic prefix (CP). If normal CP is used, each slot may include 14 symbols. If an extended CP is used, each slot may include 12 symbols. Here, the symbol may include an OFDM symbol (or a CP-OFDM symbol) and an SC-FDMA symbol (or a DFT-s-OFDM symbol).

Table 1 shows the number of symbols per slot according to SCS, the number of slots per frame and the number of slots per subframe when normal CP is used, and Table 2 shows the number of symbols per slot according to SCS, the number of slots per frame and the number of slots per subframe when extended CP is used.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

TABLE 2

| μ | ${N}_{symb}^{slot}$ | ${N}_{slot}^{frame , μ}$ | ${N}_{slot}^{subframe , μ}$ |
|---|---|---|---|
| 2 | 12 | 40 | 4 |

In Tables 1 and 2 above,

$${N}_{symb}^{slot}$$

may indicate the number of symbols in a slot,

$${N}_{slot}^{frame , μ}$$

may indicate the number of slots in a frame, and

$${N}_{slot}^{subframe , μ}$$

may indicate the number of slots in a subframe.

In addition, in a system, to which the present disclosure is applicable, OFDM(A) numerology (e.g., SCS, CP length, etc.) may be differently set among a plurality of cells merged to one UE. Accordingly, an (absolute time) period of a time resource (e.g., an SF, a slot or a TTI) (for convenience, collectively referred to as a time unit (TU)) composed of the same number of symbols may be differently set between merged cells.

NR may support a plurality of numerologies (or subscriber spacings (SCSs)) supporting various 5G services. For example, a wide area in traditional cellular bands is supported when the SCS is 15 kHz, dense-urban, lower latency and wider carrier bandwidth are supported when the SCS is 30 kHz/60 kHz, and bandwidth greater than 24.25 GHz may be supported to overcome phase noise when the SCS is 60 kHz or higher.

An NR frequency band is defined as two types (FR1 and FR2) of frequency ranges. FR1 and FR2 may be configured as shown in the following table. In addition, FR2 may mean millimeter wave (mmW).

TABLE 3

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

In addition, for example, in a communication system, to which the present disclosure is applicable, the above-described numerology may be differently set. For example, a terahertz wave (THz) band may be used as a frequency band higher than FR2. In the THz band, the SCS may be set greater than that of the NR system, and the number of slots may be differently set, without being limited to the above-described embodiments.

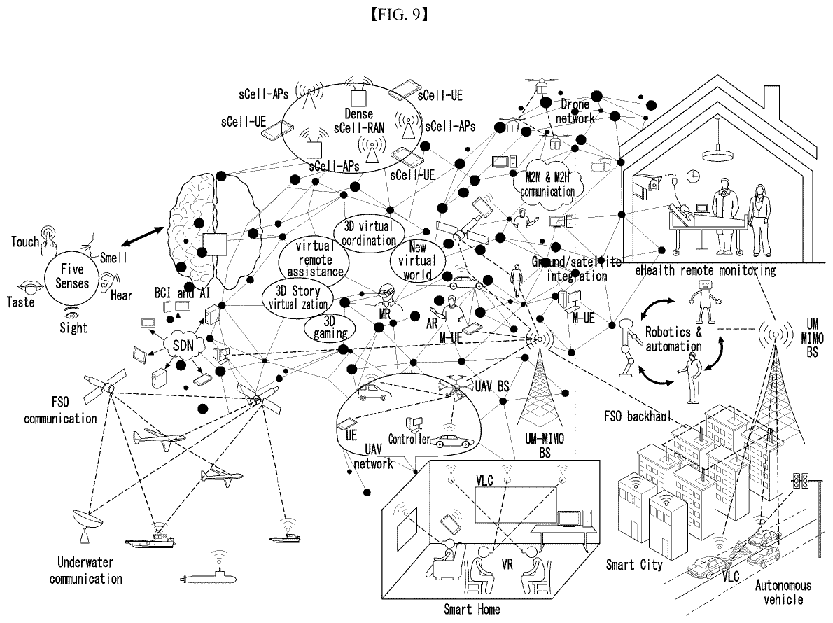

FIG. 8 illustrates a slot structure applicable to the present disclosure.

One slot includes a plurality of symbols in the time domain. For example, one slot includes seven symbols in case of normal CP and one slot includes six symbols in case of extended CP. A carrier includes a plurality of subcarriers in the frequency domain. A resource block (RB) may be defined as a plurality (e.g., 12) of consecutive subcarriers in the frequency domain.

In addition, a bandwidth part (BWP) is defined as a plurality of consecutive (P)RBs in the frequency domain and may correspond to one numerology (e.g., SCS, CP length, etc.).

The carrier may include a maximum of N (e.g., five) BWPs. Data communication is performed through an activated BWP and only one BWP may be activated for one UE. In resource grid, each element is referred to as a resource element (RE) and one complex symbol may be mapped.

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 4 shows the requirements of the 6G system.

TABLE 4

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

FIG. 9 illustrates an example of a communication structure providable in a 6G system applicable to the present disclosure.

Referring to FIG. 9, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In addition, in 6G, new network characteristics may be as follows.
Satellites integrated network: To provide a global mobile group, 6G will be integrated with satellite. Integrating terrestrial waves, satellites and public networks as one wireless communication system may be very important for 6G.
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.
Ubiquitous super 3-dimemtion connectivity: Access to networks and core network functions of drones and very low earth orbit satellites will establish super 3D connection in 6G ubiquitous.

In the new network characteristics of 6G, several general requirements may be as follows.
Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network composed of heterogeneous networks improves overall QoS and reduces costs.
High-capacity backhaul: Backhaul connection is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability.

### Quantum Communication

Quantum communication is a next-generation communication technology that can overcome the limitations of existing information and communication, such as security and ultra-fast computation, by applying quantum mechanical properties to the information and communication field. The quantum communication provides a means to generate, transmit, process, and store information in the form that cannot be expressed or is difficult to express in the form of 0 and 1 according to binary bit information used in existing communication technologies. In the existing communication technologies, wavelengths, amplitudes, or the like have been used for information transmission between a transmitting terminal and a receiving terminal, but in the quantum communication, a photon, which is the smallest unit of light, is used for the information transmission between the transmitting terminal and the receiving terminal. In particular, the quantum communication can utilize quantum uncertainty, quantum irreversibility, and non-cloning for the polarization or phase difference of photons (light), and thus the quantum communication has the characteristic of enabling communication with perfect security. The quantum communication can also enable ultra-fast communication using quantum entanglement under certain conditions.

The present disclosure proposes a method and a device therefor that can be applied to a user authentication process of various quantum communication protocols including a quantum key distribution (QKD) system which is being applied as a security technology for 4G/5G communication networks, quantum direct communication (QDC) which safely transmits message information through a quantum channel, or the like. Here, the user authentication refers to a procedure for verifying whether a transmitting entity and a receiving entity exchanging information through a channel is an authorized entity, and the channel may include a classical channel, a quantum channel, or the like. More specifically, the present disclosure eliminates the ideal assumption in an existing authentication method that perform authentication using information transmitted through a classical channel, the possibility of information manipulation/forgery by an eavesdropper in the existing authentication method, etc. by performing user authentication between a transmitting terminal and a receiving terminal using information transmitted through a quantum channel, thereby providing an efficient user authentication method that complements drawbacks of the existing authentication method and can reuse existing resources without generating additional resources for authentication.

### DEFINITION OF TERMS

For convenience of description, the following symbols/abbreviations/terms may be used in the present disclosure.
QDC: Quantum Direct Communication
QSDC: Quantum Secure Direct Communication
QBER: Quantum Bit Error Rate
QKD: Quantum Key Distribution
MIMA: Man-in-middle-attack
MAC: Message Authentication Code
WCA: Wegman-Carter Authentication
OTP: One Time Pad
ITS: Information Theoretically Secure

Below, the general contents of user authentication are first described to help the understanding of a method described in the present disclosure.

### Man-In-the-Middle (MITM) Attack and User Authentication General

In quantum communication, the security of information transmitted through a quantum channel is guaranteed through the non-cloning theorem which is quantum mechanical properties. More specifically, it is possible to detect whether message information transmitted on the quantum channel has been eavesdropped by a third party through a process of estimating a quantum bit error rate (QBER) using some of the information transmitted through the quantum channel, and the security of the transmitted message can be guaranteed through this. However, as illustrated in FIG. 10 that illustrates an example of a man-in-the-middle (MITM) attack that may occur in quantum communication, if a third party Eve 1030 exists between Alice 1010 which is a transmitting terminal and Bob 1020 which is a receiving terminal, and attempts a man-in-the-middle attack where Eve 1030 acts as a receiving terminal to Alice 1010 and acts as a transmitting terminal to Bob 1020, a QBER estimation result through information transmission between Alice 1010 and Eve 1030 and a QBER estimation result through information transmission between Eve 1030 and Bob 1020 cannot check whether the third party Eve 1030 has performed the man-in-the-middle attack. Through the man-in-the-middle attack, the third party Eve 1030 can know the contents of all data transmitted while relaying data between Alice 1010 and Bob 1020 and can also attempt to falsify/modify the data. Therefore, a user authentication process is required to verify that the transmitting terminal and the receiving terminal, which are the entities exchanging information, are authorized users, in order to prevent the man-in-the-middle attack.

Existing authentication schemes may be divided into a hash function-based authentication scheme including cryptographically strong elements and an authentication scheme based on information-theoretic security. In the hash function-based authentication scheme, the collision probability of hash functions is used as an authentication technology based on computational complexity, and an SHA scheme is a representative hash function-based technology. However, since the hash function-based authentication scheme are based on the computational complexity, they are likely to face security threats in the future due to the emergence of quantum computers. In addition, in a quantum cryptography communication system, an authentication scheme that uses a keyed hash function family that combines a symmetric key and a hash function based on information-theoretic security is applied and used to strengthen security, and quantum communication standard organizations such as the European Telecommunications Standards Institute (ETSI) have been adopted a method that uses a keyed hash function family as a standard authentication method. The above method uses a hash function called Strongly Universal Hashing as a message authentication code (MAC) algorithm to generate a message authentication code (MAC) to be used in the authentication process, and additionally uses a symmetric key used as a one-time pad (OTP) during the generation process. Since it is very unlikely that information can be recovered through the reverse process from the MAC if the symmetric key information is not known, it is known to have the highest level of security. A representative example of the method using the keyed hash function family includes the Wegman & Carter Authentication (WCA) scheme proposed by M. Wegman and J. Carter.

### Message Authentication Code (MAC) by Wegman & Carter

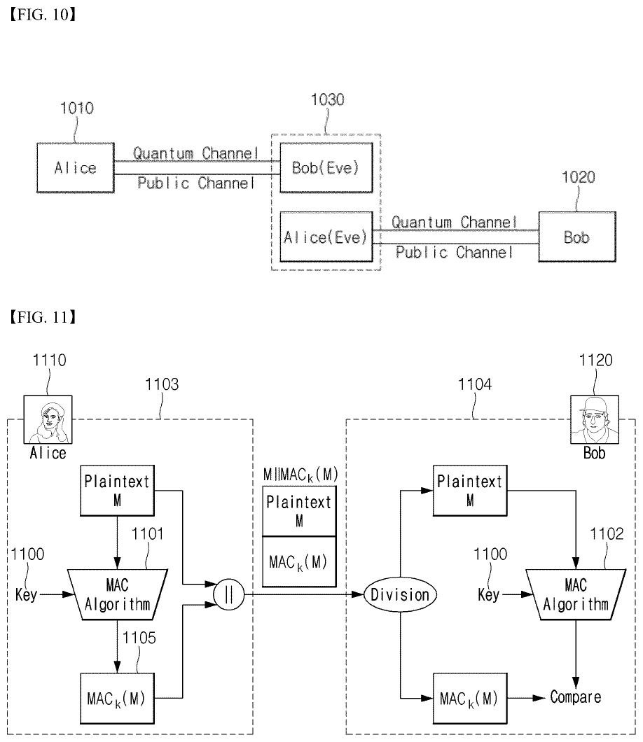

FIG. 11 illustrates an example of a MAC-based authentication scheme.

A MAC is used to verify the integrity of a message, and is an authentication scheme based on the fact that it is difficult for a third party who does not know one-time symmetric key information pre-shared between a transmitting terminal 1110 and a receiving terminal 1120 to know which MAC algorithm was used when generating the MAC. First, before an authentication process is performed, the transmitting terminal 1110 and the receiving terminal 1120 share the same symmetric key information 1100 and MAC algorithms 1101 and 1103. Thereafter, when the transmitting terminal 1110 inputs a plaintext message to be used for authentication into the MAC algorithm 1101, which of the MAC algorithms to be used is selected from a value of the pre-shared key 1100. Next, when a plaintext message 1103 is input to the MAC algorithm 1101 selected by the transmitting terminal 1110, a MAC 1105 is obtained as its output value, and the transmitting terminal 1110 transmits the plaintext message 1103 and the MAC 1105 generated by the transmitting terminal 1110 through a classical channel in order to generate a MAC at the receiving terminal 1120. The receiving terminal 1120 inputs a received plaintext message 1104 into a MAC algorithm 1102 of the receiving terminal 1120. In this instance, since the receiving terminal 1120 has the same pre-shared key as the transmitting terminal 1110, the receiving terminal 1120 can generate the MAC using the same MAC algorithm 1102 as the transmitting terminal 1110. Finally, the receiving terminal 1120 compares whether the MAC 1105 transmitted by the transmitting terminal 1110 and the MAC generated by the receiving terminal 1120 match each other. If the value of the MAC 1105 transmitted by the transmitting terminal 1110 matches the value of the MAC generated by the receiving terminal 1120, authentication is passed/successful, if the two values do not match, authentication fails.

In the case of the authentication method using the MAC, the pre-shared symmetric key information is not information transmitted through the classical channel, but is information included in only the pre-arranged transmitting and receiving terminals. Therefore, even if the third party who does not know the pre-shared symmetric key information obtains message information, the third party, who has not obtained the symmetric key information, cannot know which MAC algorithm has been applied from the message information obtained by the third party, and thus security can be guaranteed. Accordingly, it can be understood that the security of the authentication method using the MAC is higher as the number of methods of configuring the MAC algorithm increases.

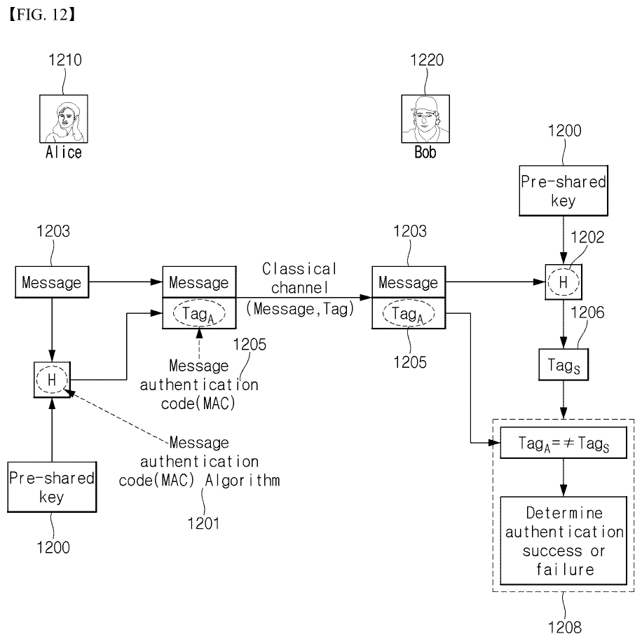

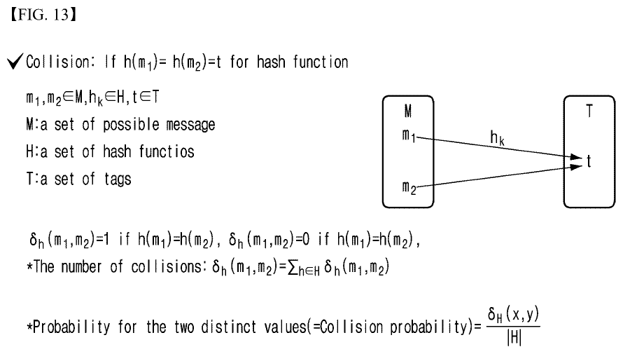

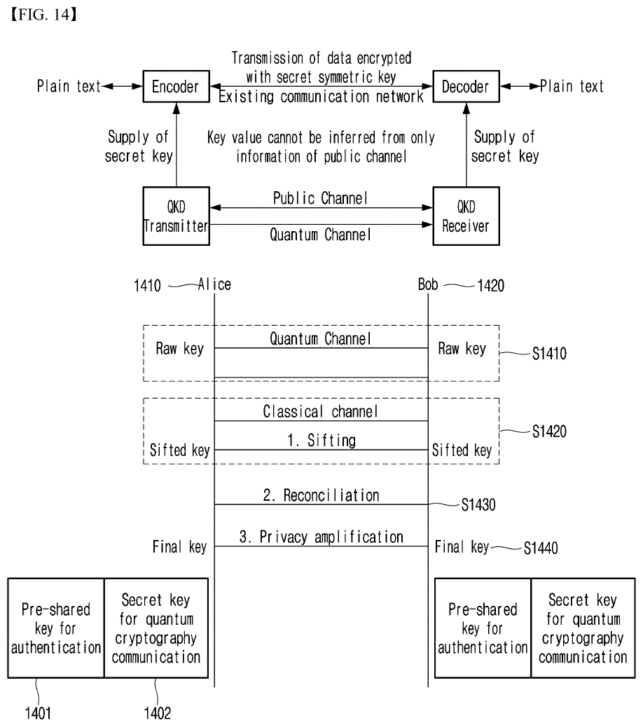

In a quantum key distribution (QKD) protocol that is currently applied as a security technology for 4G LTE/5G, the WCA scheme proposed by Wegman and Carter is adopted and used as a standard authentication technology, and a method is used to generate a tag with the MAC to be used for authentication using a symmetric key generated in the form of a one-time pad and a Strongly Universal Hash class. FIG. 12 illustrates an example of an authentication scheme based on Wegman & Carter Authentication (WCA).

The authentication method of FIG. 12 can be applied to both user authentication for checking whether a sender and a receiver have changed during message transmission, and message authentication for checking whether the content and order of message information have changed. In FIG. 12, similar to the MAC method of FIG. 11, a transmitting terminal 1210 uses a pre-shared key 1200 and a MAC algorithm 1201 to generate tag information 1205 acting as a MAC from message information 1203, and a hash function of the Strongly Universal Hash class is used as the MAC algorithm. In this instance, the pre-shared key information 1200 plays a role in selecting which hash function hₖ to use in H (1201 and 1202) of the transmitting terminal 1210 and a receiving terminal 1220, and a length of the pre-shared key is allocated as log₂|H| bits, where |H| denotes the number of hash functions constructing a hash function set. The tag information 1205 is expressed as T=hₖ(m), and a message m of the authentication process is obtained from a result obtained after passing through a hash function hₖ selected from a pre-shared key as an input value. Thereafter, the receiving terminal 1220 uses the message 1203 received by the receiving terminal 1220 to compare tag information 1206 of the receiving terminal 1220 obtained from the pre-shared key 1200 and the hash function 1202 of the receiving terminal 1220 with the tag information 1205 received from the transmitting terminal 1210, and determines whether authentication (1208) is performed after checking whether the two tag informations match.

As mentioned above, the Wegman & Carter authentication scheme uses the hash function as the MAC algorithm. The hash function is a function that receives information with arbitrary length and outputs the information as a hash value of fixed length. It is also called a message digest because the original length of the sentence is reduced to a certain length.

The hash function may be used as the MAC in the authentication process based on the following three properties.

One-wayness: For a given arbitrary output value y, it is computationally infeasible to find an input value x satisfying y=h(x).

Second preimage resistance: There is h(x) for a given input value x, and when h(x)=h(x′), it is computationally infeasible to find another input value x′ satisfying x=/x′.

Collision resistance): It is computationally infeasible to find the two input values x and x′ satisfying hash values h(x)=h(x′).

FIG. 13 illustrates a correlation between the number of hash functions and the probability of collision.

In the WCA, when a third party, eve, attempts a man-in-the-middle attack by replacing a message m with m′ and guessing a tag to send it, eve does not know which hash function a transmitting terminal and a receiving terminal used. Therefore, eve guesses the tag by selecting a random hash function, so a success rate of the man-in-the-middle attack is 1/|T|, where |T| denotes the number of tags. In other words, since the number of tags is determined by the number of types |H| of hash functions used, the more types of hash functions used, the lower the probability that eve will guess the tag. Therefore, as shown in the collision probability formula in FIG. 13, the larger the number of hash functions, the lower the collision probability.

The following problems can be solved through the user authentication method proposed in the present disclosure.

(1) In the existing authentication scheme, user authentication for a secret key transmitted on a quantum channel or user authentication for message information is performed through a classical channel, and thus there is a possibility of a man-in-the-middle attack through the quantum channel on which actual message information is transmitted.

More specifically, user authentication of a QKD protocol, which is a representative user authentication protocol, uses a method in which secret key information is exchanged between a transmitting terminal and a receiving terminal through a quantum channel, and then user authentication is performed in a classical channel. However, since this authentication method includes the ideal assumption that the quantum channel and the classical channel are always connected between the same users, a man-in-the-middle attack may be is attempted in the quantum channel even if Eve does not exist in the classical channel. In this case, the QKD scheme cannot secure/guarantee unconditional security. In general quantum communication schemes as well as the QKD, the classical channel and the quantum channel are used, and verification of the sender and receiver of a message transmitted on the quantum channel must be based on information transmitted on the quantum channel, so that the integrity of a user of the information transmitted on the quantum channel can be guaranteed. Therefore, an authentication scheme using authentication message information transmitted on the quantum channel is required.

(2) Additional generation of authentication message information to be used for user authentication is required.

More specifically, in the existing authentication scheme, the transmitting terminal separately generates message information for user authentication in addition to a message and QBER estimation information, and uses the separately generated message information for user authentication as input information for MAC generation in the authentication process. The fact that additional authentication information is separately generated may result in a greater time delay factor in quantum communication between the transmitting terminal generating transmission information for a single block and sending transmission information for a next block. In addition, from an implementation perspective, greater power consumption occurs in the process of creating more signals. Accordingly, a method is required for generating information for user authentication without allocating additional resources for generating a separate message for user authentication.

(3) In the existing authentication scheme using the symmetric key, a method is needed to update a symmetric key used once with new symmetric key information to ensure security, but there is no method for updating the symmetric key information. In addition, in the QKD, which is only a method of updating the symmetric key, a method is used to convert some of the secret keys used for encryption of transmitted classical information into authentication key information for updating the symmetric key used for authentication, so there is a problem that the efficiency of secret key generation is reduced.

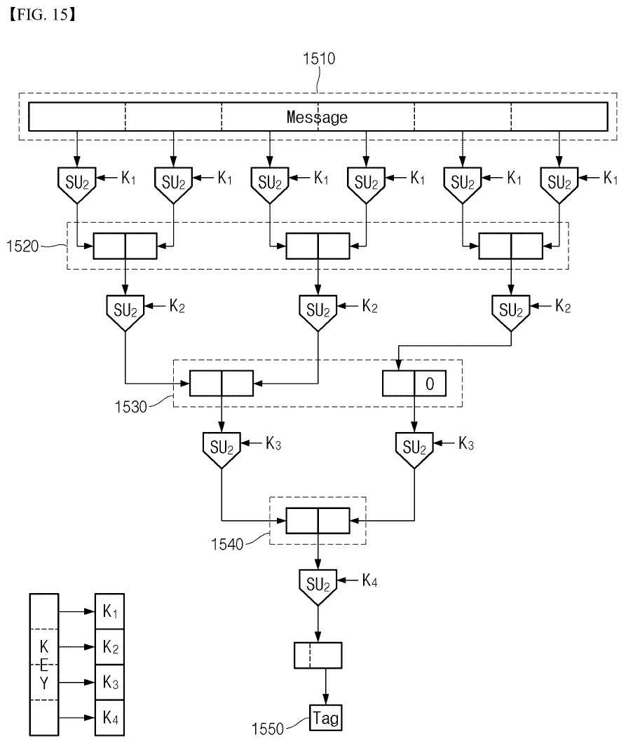

FIG. 14 illustrates an example of a method of updating a symmetric key in a quantum key distribution scheme. Referring to FIG. 14, in the quantum key distribution (QKD), after information is exchanged on a quantum channel in S1410, final keys are obtained through post-processing processes through a classical channel in S1420 to S1440. After that, some of the final keys are used as pre-shared keys to be used in a next authentication process (1401), and the previously used pre-shared keys are discarded after one use. Therefore, a significant portion of the secret keys obtained through a complex process cannot be used to encrypt classical message information to be transmitted, but are used as authentication messages, which causes a problem in that the efficiency of generating the secret keys is reduced. In the quantum communication schemes other than the QKD, the pre-shared key used in the authentication process cannot be reused and must be discarded and reupdated, in order to ensure security. However, since an updating method has not been clearly presented to date, a method for efficiently renewing the pre-shared key is required.

(4) In the existing authentication scheme, a large-sized hash function set is used as the MAC algorithm, and a complex operation process of a tree structure must be performed to generate tag information from the hash function, so the tag generation process has a high level of complexity.

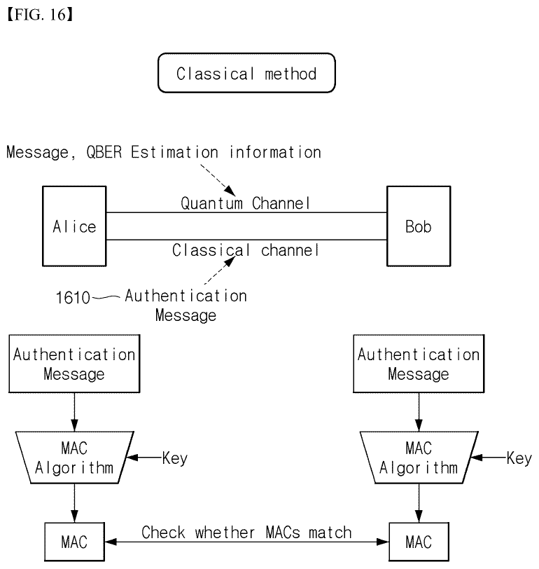

FIG. 15 illustrates an example of a tag generation process in the existing authentication scheme. Referring to FIG. 15, in the existing authentication scheme proposed by Wegman & Carter, an authentication message is divided into several blocks (1510). Then, the blocks are grouped into two and passed through a strongly universal (SU) hash function selected by a first pre-shared key to generate an output value corresponding to one block (1520). Then, the reduced blocks are grouped into two again and passed through a hash function selected by a second pre-shared key. This process is repeated until only one hash output corresponding to a final block remains (1530 and 1540). Among them, only the block corresponding to a length of a lowest tag is separated and used as tag information (1550). As above, the existing authentication scheme is very complex because the MAC algorithm, which uses the message as an input value and outputs the tag as an output value, follows an iterative compression method of Tree structure.

A method for solving the above-mentioned problems is described in detail below. More specifically, the present disclosure proposes a method and device configuration for performing authentication based on information transmitted on a quantum channel, so that an authentication process of a transmitting terminal and a receiving terminal, which are the subjects of transmission, excludes the possibility of a third-party attack that occurs in the existing authentication scheme performed with subjects connected through a classical channel, even though information is transmitted on the quantum channel. The present disclosure also proposes a method of reusing checking sequence information transmitted on a quantum channel for QBER estimation as authentication message information without separately generating message information required for the authentication process. Through this, authentication can be performed without generating additional information for user authentication. The present disclosure also proposes a method of simply performing authentication by utilizing a pre-shared symmetric key and authentication message information without using a complex MAC algorithm. The present disclosure also proposes a method of discarding a pre-shared symmetric key used once and updating it to a new symmetric key for security after a transmitting terminal and a receiving terminal perform authentication. In the present method, a method of generating a new symmetric key by combining the transmitted message and the pre-shared symmetric key used can be used.

The method proposed in the present disclosure performs the user authentication process in the following order.

(1) First, the transmitting terminal generates sequence information for QBER estimation.

(2) Next, the transmitting terminal transmits the sequence information for QBER estimation through a quantum channel, and then determines whether to proceed with the QBER estimation and authentication through an estimation result through measurement at the receiving terminal.

(3) When authentication is performed based on the QBER estimation result, the transmitting terminal and the receiving terminal perform an error correction process for reusing the information used for QBER estimation and using it as message information for authentication. Through this process, the message information to be used for authentication at the transmitting terminal and the receiving terminal can be matched.

(4) Finally, each of the transmitting terminal and the receiving terminal uses message information to be used for error-corrected authentication as an input value, generates MAC using pre-shared key information, and compares the MACs generated by each of the transmitting terminal and the receiving terminal to perform the user authentication process based on whether the MACs match each other.

First, the present disclosure describes a method of solving the problem of additional resource allocation for authentication by reusing the information transmitted for QBER estimation on a quantum channel as message information for the user authentication scheme after QBER estimation.

### User Authentication Scheme Reusing Information Used for QBER Estimation

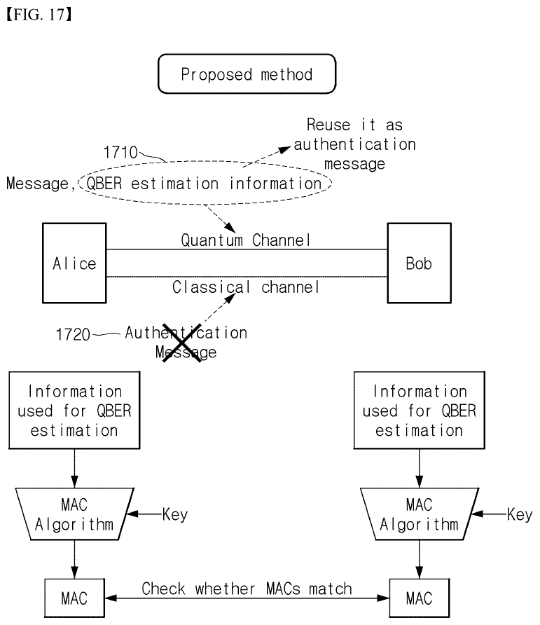

FIG. 16 illustrates an example where user authentication is performed through a classical channel in quantum communication.

Referring to FIG. 16, message information 1610 for authentication is separately generated, and the generated message information 1610 is shared through a classical channel. A transmitting terminal and a receiving terminal each use the same message information 1610 for authentication as an input value of a MAC algorithm to output a MAC used for authentication, and then perform an authentication process by applying a WCA scheme that compares MAC values between the transmitting terminal and the receiving terminal.

FIG. 17 illustrates an example of performing user authentication using QBER estimation information transmitted on a quantum channel in quantum communication. More specifically, FIG. 17 illustrates a user authentication method performed by reusing information used for QBER estimation. Referring to FIG. 17, checking sequence information 1710 used in a QBER estimation process to check whether message information transmitted on a quantum channel has been eavesdropped is reused as message information for user authentication after the QBER estimation process is completed. That is, the user authentication method described in the present disclosure uses the checking sequence information used for QBER estimation as message information for authentication and applies it as an input value of a MAC algorithm. Thereafter, a MAC value to be used for authentication is derived through the MAC algorithm based on a pre-shared key. Next, the transmitting terminal and the receiving terminal derive the MAC value through the same process and determine whether the authentication passes by checking whether the two values match.

Unlike the existing user authentication method, the method described in the present disclosure does not separately generate the message information for authentication, and thus has the effect of not requiring additional resource allocation for the authentication process. In the existing user authentication method that performs authentication using the message information transmitted on the classical channel, an ideal assumption is required that the quantum channel and the classical channel are always connected to the same sender and receiver. Through this assumption, although transmission information is transmitted on the quantum channel, if the user authentication is performed by transmitting authentication information on the classical channel, it is determined that the user authentication is completed through the assumption that the quantum channel is also connected to the same sender and receiver. However, in the method described in the present disclosure, since authentication is performed using information transmitted on the quantum channel, the integrity of the transmitting terminal and the receiving terminal connected to the quantum channel can be directly verified without the assumption of an ideal situation.

### User Authentication Method Based on the Use of Pre-Shared Symmetric Key

This method relates to a method for solving the problem of high configuration complexity of a complex MAC algorithm used in the existing user authentication method. More specifically, this method proposes three user authentication methods based on the role/usage of a pre-shared symmetric key.

### Method of Using Pre-Shared Symmetric Key to Determine Location of Authentication Information

This method uses a pre-shared symmetric key to determine a location of authentication information. More specifically, based on a location of each bit of a bit string constituting the pre-shared symmetric key and a bit value of the location, bits of authentication information corresponding to the locations of the respective bits are used as authentication information.

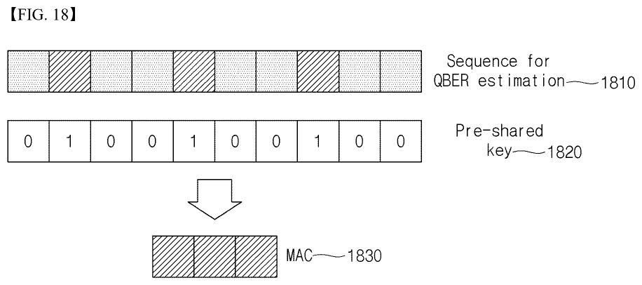

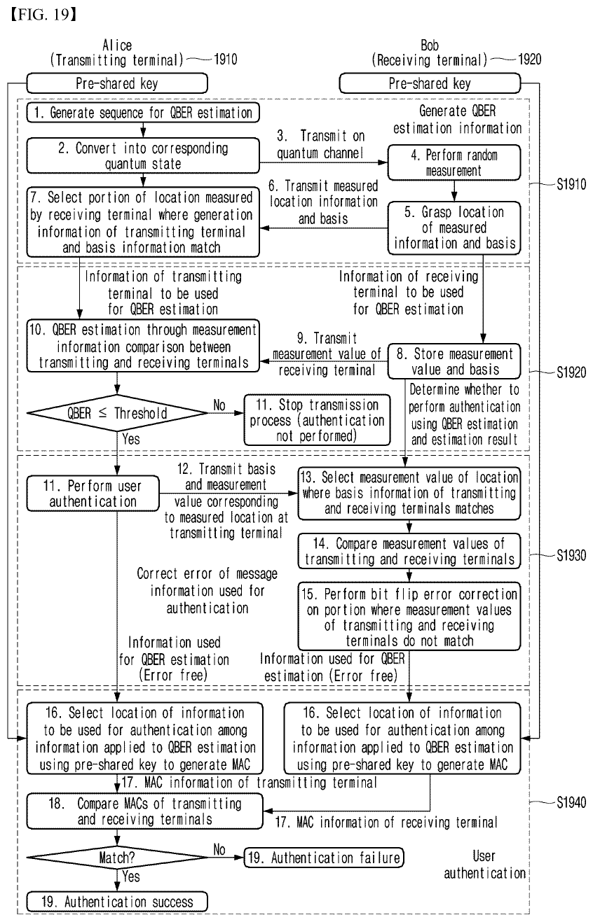

FIG. 18 illustrates a method in which a pre-shared symmetric key is used to determine a location of authentication information. Referring to FIG. 18, a pre-shared symmetric key 1820 is used to select a part of a checking sequence 1810 for QBER estimation, which is message information input for MAC generation, and some bits selected by the pre-shared symmetric key 1820 among bits of the entire checking sequence 1810 constitute the MAC. That is, the pre-shared symmetric key 1820 is used to determine a value at which location of the checking sequence 1810 will be used as MAC information for authentication. More specifically, in a bit string constituting the pre-shared symmetric key, a checking sequence value corresponding to a location of a bit with a bit value of 1 is extracted, and the extracted sequence is used as the MAC information. The remaining sequences other than the extracted sequence, that is, the checking sequence values corresponding to locations of bits with the bit value of 0 are not used as the MAC information and are discarded. Conversely, the checking sequence value corresponding to a location of a bit with the bit value of 0 may be extracted, and the extracted sequence may be used as the MAC information. In the present method, a length of the bit string constituting the pre-shared symmetric key and a length of a bit string constituting the reused checking sequence may be the same. In summary, at least one bit in the bit string of the reused checking sequence at a location corresponding to a location of at least one bit having a specific bit value in the bit string of the pre-shared symmetric key may be used as an authentication message (MAC).

Since only the transmitting terminal and the receiving terminal that have been agreed upon in advance have the same symmetric key, the transmitting terminal and the receiving terminal can generate the same MAC information, and this method may be used as an authentication method between the transmitting terminal and the receiving terminal. This method can generate MAC information from an authentication message with low complexity when configuring an authentication protocol without using the complex MAC algorithm as in the existing method.

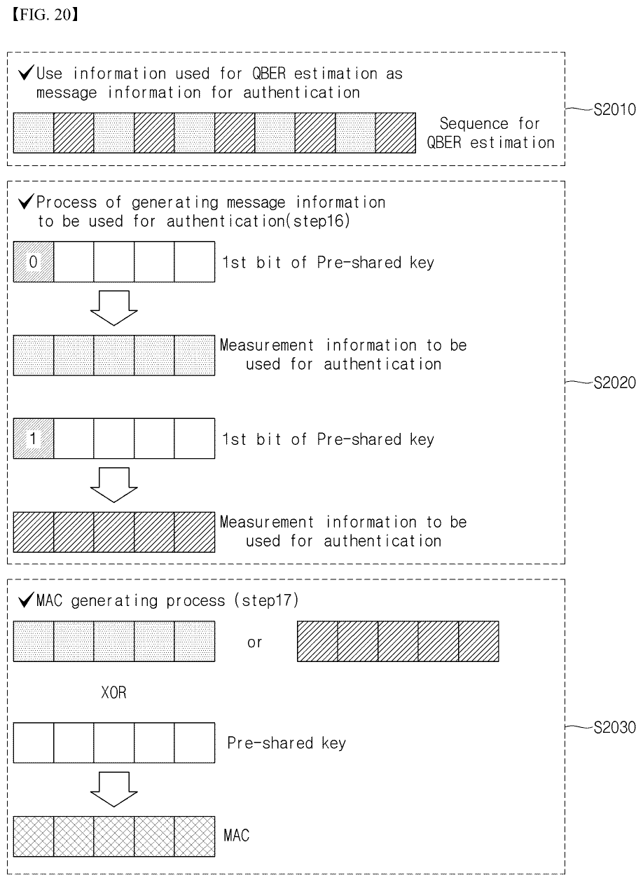

FIG. 19 is a flowchart illustrating a user authentication process to which a method described in the present disclosure is applied.

S1910: In this step, QBER estimation information is generated. More specifically, a transmitting terminal 1910 generates QBER estimation information (checking sequence) (1.) and converts it into a quantum state corresponding to a value of the QBER estimation information to transmit it to a receiving terminal 1920 on a quantum channel (2. and 3.). Thereafter, the receiving terminal 1920 measures the QBER estimation information converted into the quantum state based on a random measurement (4.) and grasps a location of the measured information and a basis used for the measurement (5.). Next, the receiving terminal 1920 transmits information on the location of the measured information and information on the basis used for the measurement to the transmitting terminal 1910 (6.). Next, the transmitting terminal 1910 selects information corresponding to the location where the receiving terminal 1920 performs the measurement using the same basis as the basis used for the quantum state conversion at the transmitting terminal (7.).

S1920: In this step, whether to perform authentication using the QBER estimation and the estimation result is determined. More specifically, the receiving terminal 1920 stores a measured value and the basis (8.). Next, the receiving terminal 1920 transmits the measured value at the receiving terminal to the transmitting terminal 1910 (9.). Thereafter, the transmitting terminal 1910 compares the information generated and transmitted by the transmitting terminal 1910 with the measured value at the receiving terminal 1920 to perform the QBER estimation (10.). In this instance, if the QBER estimation value is equal to or less than a preset threshold, user authentication is performed, and if the QBER estimation value is greater than the preset threshold, the transmission process is stopped and the user authentication is not performed (11.).

S1930: In this step, a process for matching message information for authentication used by the transmitting terminal and the receiving terminal is performed. More specifically, since a certain percentage of errors occur in the checking sequence for QBER estimation transmitted as the authentication message information through the quantum channel due to the quantum channel passage process, etc., the checking sequences at the transmitting terminal and the receiving terminal may not completely match. That is, if the QBER estimation result (e.g., 5%) is lower than the threshold (e.g., 11%), it may be determined that there is no eavesdropper. However, if the value of the QBER estimation result is not 0, the non-zero value of the QBER estimation result may be due to a certain percentage of errors occurring in the QBER estimation checking sequence due to the quantum channel passage process, etc. Hence, the checking sequence generated by the transmitting terminal 1910 and the checking sequence determined from the value measured by the receiving terminal 1920 may not completely match. In this instance, if the checking sequence generated by the transmitting terminal 1910 and the checking sequence measured by the receiving terminal 1920, which do not completely match, are applied as message values for authentication at the transmitting terminal and the receiving terminal, the transmitting terminal 1910 and the receiving terminal 1920 cannot output the same MAC due to message mismatch, so authentication always fails. In order to solve the problem that the checking sequence generated by the transmitting terminal 1910 and the checking sequence measured by the receiving terminal 1920 do not completely match, a step S1930, which is an error correction process of message information to be used for authentication, may be added. Through the step S1930, the checking sequence generated by the transmitting terminal 1910 and a reception checking sequence in which an error occurred due to the reception process at the receiving terminal 1920 may completely match.

More specifically, the transmitting terminal 1910 initiates the user authentication process (11.) and transmits a basis and a measurement value corresponding to the measured location (12.). In other words, the transmitting terminal 1910 transmits (i) location information on which basis has been used to convert bits constituting the checking sequence into a quantum state and (ii) information on the checking sequence value converted into the quantum state. Next, the receiving terminal 1920 selects only measurement values corresponding to the location where the basis used for the quantum state conversion at the transmitting terminal 1910 and the basis used for the measurement at the receiving terminal 1920 are the same, based on the location information (13.), and compares the information on the checking sequence value converted into the quantum state transmitted by the transmitting terminal 1910 with the value measured by the receiving terminal 1920 (14.). As a result of the comparison, a bit flip error correction is performed on a portion where the information received from the transmitting terminal 1910 and the value measured by the receiving terminal 1920 do not match (15.).

S1940: In this step, user authentication is performed. More specifically, since the message information to be used in the authentication process of the transmitting terminal and the receiving terminal matches through the step S1930, based on the matched message information (checking sequence), the transmitting terminal and the receiving terminal each apply the method described in FIG. 18 (the pre-shared symmetric key is used to determine the location of the message information to be used as the MAC) to generate and output the MAC (16.). Thereafter, the receiving terminal 1920 transmits the generated MAC to the transmitting terminal 1910 (17.). The transmitting terminal 1910 compares the MAC generated by the transmitting terminal 1910 with the MAC received from the receiving terminal 1920 (18.). If the MAC of the transmitting terminal 1910 and the MAC of the receiving terminal 1920 match, it is determined that the authentication is successful, and if the MAC of the transmitting terminal 1910 and the MAC of the receiving terminal 1920 do not match, it is determined that the authentication is failed. In this instance, even if there is a third party attempting a man-in-the-middle attack on the channel between the transmitting terminal and the receiving terminal, the third party does not have the pre-shared symmetric key information between the transmitting terminal and the receiving terminal. Therefore, even if the third party steals the message information, the third party cannot know which location of the value is used to generate the MAC, and thus it is impossible for the third party to generate MAC information that matches the MACs generated by the transmitting terminal and the receiving terminal.

Method of Using Pre-Shared Symmetric Key in XOR Operation with Message for MAC Generation

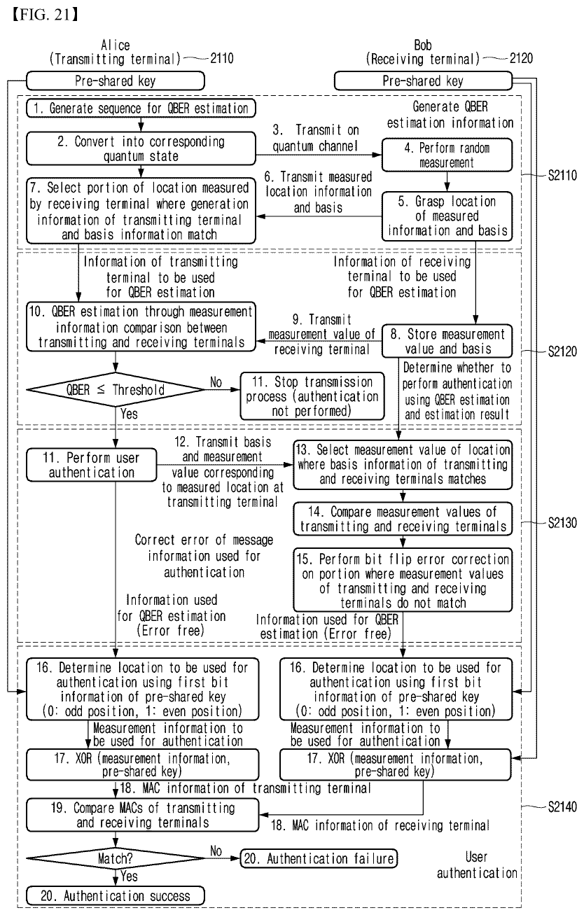

This method uses a pre-shared symmetric key for XOR operation with a message for MAC generation. FIG. 20 illustrates an example of performing a method in which a pre-shared symmetric key is used for an XOR operation with a message for MAC generation. Referring to FIG. 20, a checking sequence used for QBER estimation is used as an input message of an authentication process, in S2010, and values of odd positions or values of even positions of the input message (checking sequence) are used as input information to be used for authentication depending on values of first bit information of a pre-shared symmetric key, in S2020. Here, the pre-shared symmetric key may be configured/generated to have a length of half a length of the checking sequence. In this instance, if the value of the first bit information of the pre-shared symmetric key is 0, the value of the odd position of the input message is used as the input information to be used for authentication, and if the value of the first bit information of the pre-shared symmetric key is 1, the value of the even position of the input message is used as the input information to be used for authentication. Conversely, if the value of the first bit information of the pre-shared symmetric key is 0, the value of the even position of the input message may be used as the input information to be used for authentication, and if the value of the first bit information of the pre-shared symmetric key is 1, the value of the odd position of the input message may be used as the input information to be used for authentication. The step S2020 corresponds to step 16. of FIG. 21 described below. Through the step S2020, a size of an input value required for MAC generation is reduced by half, an XOR operation is used as a MAC algorithm, and the pre-shared symmetric key and the reduced message value are used as input values of the MAC algorithm. Thereafter, the pre-shared symmetric key and the reduced message value are XOR-operated to output the MAC, in S2030. The step S2030 corresponds to step 17. of FIG. 21 described below.

In the present method, since only a length corresponding to half of the length of the checking sequence is used for the XOR operation with the pre-shared symmetric key, the length of the pre-shared symmetric key may be configured to be shorter than the length of the checking sequence. If a length of a bit string of the checking sequence is even number, a length of a bit string of a pre-shared authentication key may be set to half of the length of the bit string of the checking sequence. Further, if the length of the bit string of the checking sequence is odd number: when the bit values of the odd positions in the bit string of the checking sequence are used to generate the authentication message, the length of the bit string of the pre-shared authentication key may be set to a length that is half the length of the bit string of the checking sequence rounded up, and when the bit values of the even positions in the bit string of the checking sequence are used to generate the authentication message, the length of the bit string of the pre-shared authentication key may be set to a length that is half the length of the bit string of the checking sequence rounded down.

FIG. 21 is a flowchart illustrating a user authentication process to which a method described in the present disclosure is applied.

S2110: In this step, QBER estimation information is generated. More specifically, a transmitting terminal 2110 generates QBER estimation information (checking sequence) (1.) and converts it into a quantum state corresponding to a value of the QBER estimation information to transmit it to a receiving terminal 2120 on a quantum channel (2. and 3.). Thereafter, the receiving terminal 2120 measures the QBER estimation information converted into the quantum state based on a random measurement (4.) and grasps a location of the measured information and a basis used for the measurement (5.). Next, the receiving terminal 2120 transmits information on the location of the measured information and information on the basis used for the measurement to the transmitting terminal 2110 (6.). Next, the transmitting terminal 2110 selects information corresponding to the location where the receiving terminal 2120 performs the measurement using the same basis as the basis used for the quantum state conversion at the transmitting terminal (7.).

S2120: In this step, whether to perform authentication using the QBER estimation and the estimation result is determined. More specifically, the receiving terminal 2120 stores a measured value and the basis (8.). Next, the receiving terminal 2120 transmits the measured value at the receiving terminal to the transmitting terminal 2110 (9.). Thereafter, the transmitting terminal 2110 compares the information generated and transmitted by the transmitting terminal 2110 with the measured value at the receiving terminal 2120 to perform the QBER estimation (10.). In this instance, if the QBER estimation value is equal to or less than a preset threshold, user authentication is performed, and if the QBER estimation value is greater than the preset threshold, the transmission process is stopped and the user authentication is not performed (11.).

S2130: In this step, a process for matching message information for authentication used by the transmitting terminal and the receiving terminal is performed. More specifically, since a certain percentage of errors occur in the checking sequence for QBER estimation transmitted as the authentication message information through the quantum channel due to the quantum channel passage process, etc., the checking sequences at the transmitting terminal and the receiving terminal may not completely match. That is, if the QBER estimation result (e.g., 5%) is lower than the threshold (e.g., 11%), it may be determined that there is no eavesdropper. However, if the value of the QBER estimation result is not 0, the non-zero value of the QBER estimation result may be due to a certain percentage of errors occurring in the QBER estimation checking sequence due to the quantum channel passage process, etc. Hence, the checking sequence generated by the transmitting terminal 2110 and the checking sequence determined from the value measured by the receiving terminal 2120 may not completely match. In this instance, if the checking sequence generated by the transmitting terminal 2110 and the checking sequence measured by the receiving terminal 2120, which do not completely match, are applied as message values for authentication at the transmitting terminal and the receiving terminal, the transmitting terminal 2110 and the receiving terminal 2120 cannot output the same MAC due to message mismatch, so authentication always fails. In order to solve the problem that the checking sequence generated by the transmitting terminal 2110 and the checking sequence measured by the receiving terminal 2120 do not completely match, a step S2130, which is an error correction process of message information to be used for authentication, may be added. Through the step S2130, the checking sequence generated by the transmitting terminal 2110 and a reception checking sequence in which an error occurred due to the reception process at the receiving terminal 2120 may completely match.

More specifically, the transmitting terminal 2110 initiates the user authentication process (11.) and transmits a basis and a measurement value corresponding to the measured location (12.). In other words, the transmitting terminal 2110 transmits (i) location information on which basis has been used to convert bits constituting the checking sequence into a quantum state and (ii) information on the checking sequence value converted into the quantum state. Next, the receiving terminal 2120 selects only measurement values corresponding to the location where the basis used for the quantum state conversion at the transmitting terminal 2110 and the basis used for the measurement at the receiving terminal 2120 are the same, based on the location information (13.), and compares the information on the checking sequence value converted into the quantum state transmitted by the transmitting terminal 2110 with the value measured by the receiving terminal 2120 (14.). As a result of the comparison, a bit flip error correction is performed on a portion where the information received from the transmitting terminal 2110 and the value measured by the receiving terminal 2120 do not match (15.).

S2140: In this step, user authentication is performed. More specifically, since the message information to be used in the authentication process of the transmitting terminal and the receiving terminal matches through the step S2130, based on the matched message information (checking sequence), the transmitting terminal and the receiving terminal each apply the method described in FIG. 20 (the pre-shared symmetric key is used for the XOR operation with input information for generating the message information to be used as the MAC) to generate and output the MAC (16.). Thereafter, the receiving terminal 2120 transmits the generated MAC to the transmitting terminal 2110 (17.). The transmitting terminal 2110 compares the MAC generated by the transmitting terminal 2110 with the MAC received from the receiving terminal 2120 (18.). If the MAC of the transmitting terminal 2110 and the MAC of the receiving terminal 2120 match, it is determined that the authentication is successful, and if the MAC of the transmitting terminal 2110 and the MAC of the receiving terminal 2120 do not match, it is determined that the authentication is failed. In this instance, even if there is a third party attempting a man-in-the-middle attack on the channel between the transmitting terminal and the receiving terminal, the third party does not have the pre-shared symmetric key information between the transmitting terminal and the receiving terminal. Therefore, even if the third party steals the message information, the third party cannot know which location of the value is used to generate the MAC, and thus it is impossible for the third party to generate MAC information that matches the MACs generated by the transmitting terminal and the receiving terminal.

In the present method, since the authentication message information is compressed and configured, the size of the pre-shared symmetric key can also be reduced by half. Since the symmetric key must be discarded and updated after one use, minimizing the size of the symmetric key is necessary to simplify an update procedure. Since QKD uses part of the secret key as the symmetric key for the authentication process, minimizing the size of the symmetric key can minimize the loss of the secret key.

### Method of Using Pre-Shared Symmetric Key to Select Hash Function to be Used for MAC Generation Among Hash Functions Constituting Hash Function Set H Used as MAC Algorithm

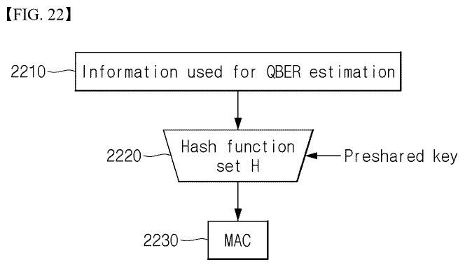

This method relates to a method in which a pre-shared symmetric key is used to select a hash function to be used for MAC generation among hash functions constituting a hash function set H used as a MAC algorithm. FIG. 22 illustrates a method in which a pre-shared symmetric key is used to select a hash function to be used for MAC generation among hash functions constituting a hash function set H used as a MAC algorithm. Referring to FIG. 22, a checking sequence 2210 used for QBER estimation is used as an input value of a hash function set used as a MAC algorithm, and a value of a pre-shared symmetric key is used to determine which hash function among many hash functions constituting a hash function set H (2220) is selected. Therefore, a length of the pre-shared key is log₂ R bits (where R is the number of hash functions constituting the hash function set H), and is set to a length that can distinguish all the hash functions constituting the hash function set H.

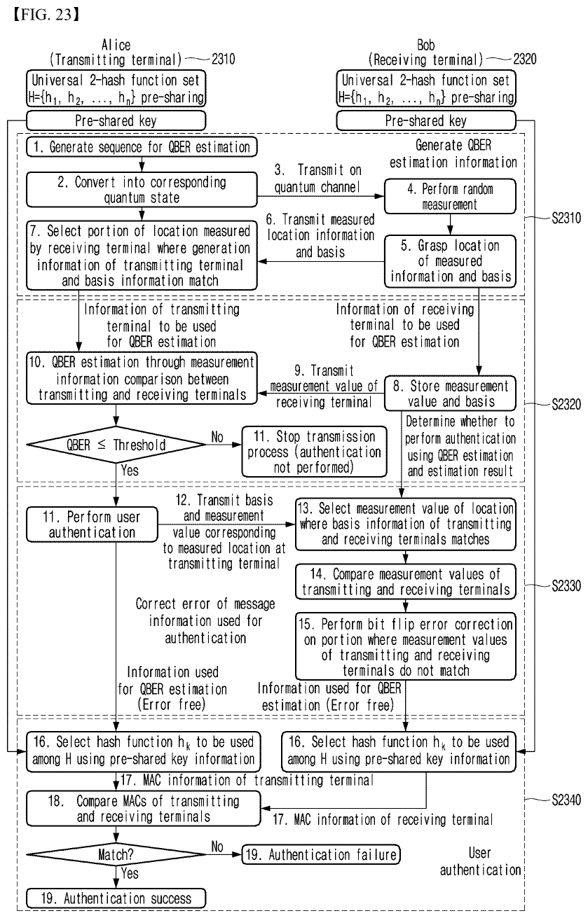

FIG. 23 is a flowchart illustrating a user authentication process to which a method described in the present disclosure is applied. In this method, transmission and reception begin an authentication process after pre-sharing not only a pre-shared key but also a Universal 2 hash function set to be used as a MAC algorithm before the authentication process.

S2310: In this step, QBER estimation information is generated. More specifically, a transmitting terminal 2310 generates QBER estimation information (checking sequence) (1.) and converts it into a quantum state corresponding to a value of the QBER estimation information to transmit it to a receiving terminal 2320 on a quantum channel (2. and 3.). Thereafter, the receiving terminal 2320 measures the QBER estimation information converted into the quantum state based on a random measurement (4.) and grasps a location of the measured information and a basis used for the measurement (5.). Next, the receiving terminal 2320 transmits information on the location of the measured information and information on the basis used for the measurement to the transmitting terminal 2310 (6.). Next, the transmitting terminal 2310 selects information corresponding to the location where the receiving terminal 2320 performs the measurement using the same basis as the basis used for the quantum state conversion at the transmitting terminal (7.).

S2320: In this step, whether to perform authentication using the QBER estimation and the estimation result is determined. More specifically, the receiving terminal 2320 stores a measured value and the basis (8.). Next, the receiving terminal 2320 transmits the measured value at the receiving terminal to the transmitting terminal 2310 (9.). Thereafter, the transmitting terminal 2310 compares the information generated and transmitted by the transmitting terminal 2310 with the measured value at the receiving terminal 2320 to perform the QBER estimation (10.). In this instance, if the QBER estimation value is equal to or less than a preset threshold, user authentication is performed, and if the QBER estimation value is greater than the preset threshold, the transmission process is stopped and the user authentication is not performed (11.).

S2330: In this step, a process for matching message information for authentication used by the transmitting terminal and the receiving terminal is performed. More specifically, since a certain percentage of errors occur in the checking sequence for QBER estimation transmitted as the authentication message information through the quantum channel due to the quantum channel passage process, etc., the checking sequences at the transmitting terminal and the receiving terminal may not completely match. That is, if the QBER estimation result (e.g., 5%) is lower than the threshold (e.g., 11%), it may be determined that there is no eavesdropper. However, if the value of the QBER estimation result is not 0, the non-zero value of the QBER estimation result may be due to a certain percentage of errors occurring in the QBER estimation checking sequence due to the quantum channel passage process, etc. Hence, the checking sequence generated by the transmitting terminal 2310 and the checking sequence determined from the value measured by the receiving terminal 2320 may not completely match. In this instance, if the checking sequence generated by the transmitting terminal 2310 and the checking sequence measured by the receiving terminal 2320, which do not completely match, are applied as message values for authentication at the transmitting terminal and the receiving terminal, the transmitting terminal 2310 and the receiving terminal 2320 cannot output the same MAC due to message mismatch, so authentication always fails. In order to solve the problem that the checking sequence generated by the transmitting terminal 2310 and the checking sequence measured by the receiving terminal 2320 do not completely match, a step S2330, which is an error correction process of message information to be used for authentication, may be added. Through the step S2330, the checking sequence generated by the transmitting terminal 2310 and a reception checking sequence in which an error occurred due to the reception process at the receiving terminal 2320 may completely match.

More specifically, the transmitting terminal 2310 initiates the user authentication process (11.) and transmits a basis and a measurement value corresponding to the measured location (12.). In other words, the transmitting terminal 2310 transmits (i) location information on which basis has been used to convert bits constituting the checking sequence into a quantum state and (ii) information on the checking sequence value converted into the quantum state. Next, the receiving terminal 2320 selects only measurement values corresponding to the location where the basis used for the quantum state conversion at the transmitting terminal 2310 and the basis used for the measurement at the receiving terminal 2320 are the same, based on the location information (13.), and compares the information on the checking sequence value converted into the quantum state transmitted by the transmitting terminal 2310 with the value measured by the receiving terminal 2320 (14.). As a result of the comparison, a bit flip error correction is performed on a portion where the information received from the transmitting terminal 2310 and the value measured by the receiving terminal 2320 do not match (15.).

S2340: In this step, user authentication is performed. More specifically, since the message information to be used in the authentication process of the transmitting terminal and the receiving terminal matches through the step S2330, based on the matched message information (checking sequence), the transmitting terminal and the receiving terminal each apply the method described in FIG. 20 (the pre-shared symmetric key is used to select a specific hash function to be used for MAC generation from the hash function set) to generate and output the MAC (16.). Thereafter, the receiving terminal 2320 transmits the generated MAC to the transmitting terminal 2310 (17.). The transmitting terminal 2310 compares the MAC generated by the transmitting terminal 2310 with the MAC received from the receiving terminal 2320 (18.). If the MAC of the transmitting terminal 2310 and the MAC of the receiving terminal 2320 match, it is determined that the authentication is successful, and if the MAC of the transmitting terminal 2310 and the MAC of the receiving terminal 2320 do not match, it is determined that the authentication is failed. In this instance, even if there is a third party attempting a man-in-the-middle attack on the channel between the transmitting terminal and the receiving terminal, the third party does not have the pre-shared symmetric key information between the transmitting terminal and the receiving terminal. Therefore, even if the third party steals the message information, the third party cannot know which location of the value is used to generate the MAC, and thus it is impossible for the third party to generate MAC information that matches the MACs generated by the transmitting terminal and the receiving terminal.

In this method, since a third party other than the transmitting terminal and the receiving terminal cannot share the pre-shared key information and the hash function set, the third party has no choice but to use one of the many hash functions constituting the hash function set to output the MAC information. Therefore, the more hash functions used, the higher the security can be guaranteed.

### Method of Updating Pre-Shared Symmetric Key

This method relates to a method of updating a pre-shared symmetric key. In a user authentication scheme using a MAC algorithm, symmetric key information is used in the form of a one-time pad (OTP) to ensure high security of an authentication process. Therefore, when one user authentication is completed, the updated symmetric key is used for a next authentication so that the same symmetric key is not repeatedly used more than twice, thereby ensuring security. In order to update symmetric key information, the QKD scheme among the existing quantum communication schemes proposes a method of using a part of a final secret key shared between a transmitting terminal and a receiving terminal as a pre-shared key for authentication, and ETSI also proposes this method as a standard scheme for updating the symmetric key.

Since general quantum communication technologies except QKD do not use secret keys, a symmetric key updating method is required for the quantum communication scheme that does not use the secret key. In this case, information that has a different value from the existing symmetric key and at the same time has a different value each time is required to update an already used symmetric key.

FIG. 24 illustrates a method of updating a pre-shared symmetric key.

Referring to FIG. 24, an XOR operation 2430 is performed to combine message information 2410 transmitted on a quantum channel, which is information that changes each time, and pre-shared key information 2420 used for the last user authentication, and a result of the XOR operation is used as an updated pre-shared key to be used for next user authentication.

Through this method, pre-shared key information for user authentication can be updated even in quantum communication schemes that do not use secret keys.

### Effect

The present disclosure proposes a method for improving the reliability and efficiency of the user authentication process of a sender and a receiver, who are users of information transmitted on a quantum channel, and can have the following effects.

(1) The present disclosure may not use additional resources for authentication by presenting a method of reusing existing transmission information without additionally generating message information for authentication. To this end, the present disclosure has described that a checking sequence used in a QBER estimation step transmitted on a quantum channel can be reused instead of discarded after the QBER estimation step is completed, and utilized as a message in the authentication process.

(2) Since the existing user authentication scheme is performed through information transmitted on a classical channel, it is possible to verify whether a user connected to the classical channel is a reliable user, but there is a limitation in the authentication process that it must assume that the quantum channel will always be the same user. To solve this problem, the present disclosure can guarantee the reliability of the authentication process by performing authentication using information used for QBER estimation transmitted on the quantum channel.

(3) The present disclosure proposes a method of generating a MAC with low complexity by using a pre-shared key value to select location information/operation factor/hash function for MAC generation, thereby solving the problem of the existing authentication scheme with high complexity by using a MAC algorithm with a complex structure such as a universal hash function and repeatedly applying a hash function and a pre-shared key in the MAC generation process.

(4) The present disclosure proposes a method of performing authentication by generating a new pre-shared key by combining newly transmitted message information and used pre-shared keys, thereby solving the problem of the existing key update scheme. That is, in order to ensure high security of the authentication process, the pre-shared key information should be discarded after one authentication process is completed, and the pre-shared key information should be updated with new key information and used in the next authentication process. However, the existing key update scheme is only presented in QKD, and there is no method of updating the pre-shared key in the authentication process of the remaining quantum communication schemes. Even in the QKD method, some of secret keys used for information encryption are used as pre-shared keys for authentication, and thus the existing key update scheme is an inefficient method of discarding some resources used for communication for the purpose of authentication. In particular, if the method proposed in the present disclosure is applied to the QKD method, unlike the existing method, some of the secret keys do not need to be used for authentication, and thus a key rate of the quantum cryptography communication process can be improved.

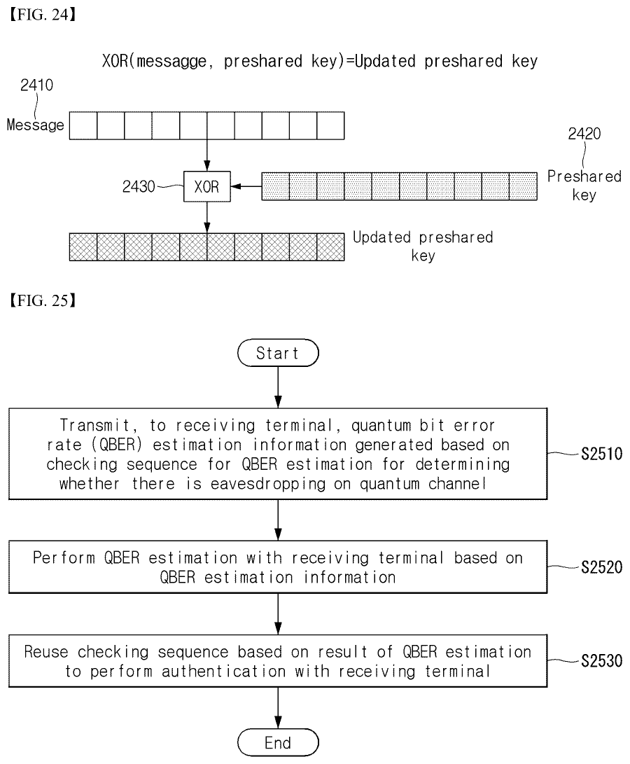

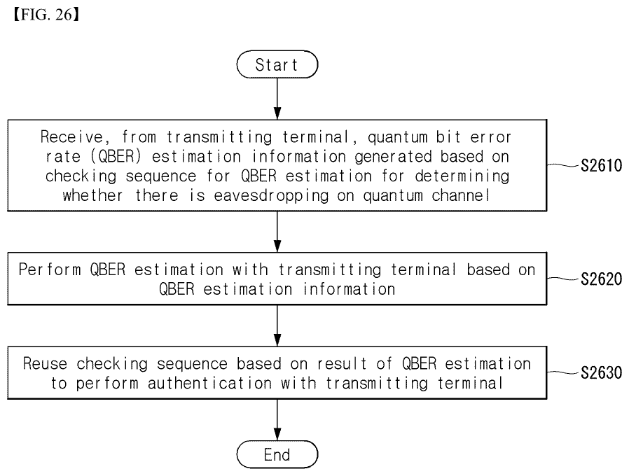

FIG. 25 is a flowchart illustrating an example in which a user authentication method described in the present disclosure is performed by a transmitting terminal.

First, the transmitting terminal transmits, to a receiving terminal, quantum bit error rate (QBER) estimation information generated based on a checking sequence for QBER estimation for determining whether there is an eavesdropping on a quantum channel, in S2510.

Next, the transmitting terminal performs the QBER estimation with the receiving terminal based on the QBER estimation information, in S2520.

Thereafter, the transmitting terminal performs an authentication with the receiving terminal by reusing the checking sequence based on a result of the QBER estimation, in S2530. In this instance, the authentication is performed based on (i) the reused checking sequence and (ii) a pre-shared symmetric key between the transmitting terminal and the receiving terminal.

The transmitting terminal includes a transmitter transmitting a radio signal; a receiver receiving the radio signal; at least one processor; and at least one computer memory operably connectable to the at least one processor and storing instructions performing operations based on being executed by the at least one processor. The operations include the steps described with reference to FIG. 25.

The operations described with reference to FIG. 25 may be stored in a non-transitory computer readable medium (CRM) storing one or more instructions. The non-transitory computer readable medium stores one or more instructions executable by one or more processors, and the one or more instructions allow the transmitting terminal to perform the operations described with reference to FIG. 25.

A device including one or more memories and one or more processors operably connected to the one or more memories controls the one or more processors so that the device performs the operations described with reference to FIG. 25.

FIG. 26 is a flowchart illustrating an example in which a user authentication method described in the present disclosure is performed by a receiving terminal.

First, the receiving terminal receives, from a transmitting terminal, quantum bit error rate (QBER) estimation information generated based on a checking sequence for QBER estimation for determining whether there is an eavesdropping on a quantum channel, in S2610.

Next, the receiving terminal performs the QBER estimation with the transmitting terminal based on the QBER estimation information, in S2620.

Thereafter, the receiving terminal performs an authentication with the transmitting terminal by reusing the checking sequence based on a result of the QBER estimation, in S2630. In this instance, the authentication is performed based on (i) the reused checking sequence and (ii) a pre-shared symmetric key between the transmitting terminal and the receiving terminal.

The receiving terminal includes a transmitter transmitting a radio signal; a receiver receiving the radio signal; at least one processor; and at least one computer memory operably connectable to the at least one processor and storing instructions performing operations based on being executed by the at least one processor. The operations include the steps described with reference to FIG. 26.

The operations described with reference to FIG. 26 may be stored in a non-transitory computer readable medium (CRM) storing one or more instructions. The non-transitory computer readable medium stores one or more instructions executable by one or more processors, and the one or more instructions allow the receiving terminal to perform the operations described with reference to FIG. 26.

A device including one or more memories and one or more processors operably connected to the one or more memories controls the one or more processors so that the device performs the operations described with reference to FIG. 26.

The embodiments described above are implemented by combinations of components and features of the present disclosure in predetermined forms. Each component or feature should be considered selectively unless specified separately. Each component or feature can be carried out without being combined with another component or feature. Moreover, some components and/or features are combined with each other and can implement embodiments of the present disclosure. The order of operations described in embodiments of the present disclosure can be changed. Some components or features of one embodiment may be included in another embodiment, or may be replaced by corresponding components or features of another embodiment. It is apparent that some claims referring to specific claims may be combined with another claims referring to the claims other than the specific claims to constitute the embodiment or add new claims by means of amendment after the application is filed.

Embodiments of the present disclosure can be implemented by various means, for example, hardware, firmware, software, or combinations thereof. When embodiments are implemented by hardware, one embodiment of the present disclosure can be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

When embodiments are implemented by firmware or software, one embodiment of the present disclosure can be implemented by modules, procedures, functions, etc. performing functions or operations described above. Software code can be stored in a memory and can be driven by a processor. The memory is provided inside or outside the processor and can exchange data with the processor by various well-known means.

It is apparent to those skilled in the art that the present disclosure can be embodied in other specific forms without departing from essential features of the present disclosure. Accordingly, the above detailed description should not be construed as limiting in all aspects and should be considered as illustrative. The scope of the present disclosure should be determined by rational construing of the appended claims, and all modifications within an equivalent scope of the present disclosure are included in the scope of the present disclosure.

### INDUSTRIAL AVAILABILITY

The present disclosure has been described focusing on examples applying to 3GPP LTE/LTE-A, the 5G system, and the quantum communication system, but can be applied to various wired/wireless communication systems in addition to 3GPP LTE/LTE-A, the 5G system, and the quantum communication system.

1. A method comprising:
transmitting, by a transmitting terminal to a receiving terminal, quantum bit error rate (QBER) estimation information generated based on a checking sequence for QBER estimation for detecting an eavesdropping on a quantum channel;
performing, by the transmitting terminal, the QBER estimation with the receiving terminal based on the QBER estimation information; and
performing, by the transmitting terminal, an authentication with the receiving terminal by reusing the checking sequence, based on a result of the QBER estimation,
wherein the authentication is performed based on (i) the reused checking sequence and (ii) a pre-shared symmetric key between the transmitting terminal and the receiving terminal.

2. The method of claim 1, further comprising transmitting, by the transmitting terminal to the receiving terminal, error correction information for correcting an error between (i) a bit value of the checking sequence generated by the transmitting terminal and (ii) a bit value of a receiving terminal checking sequence acquired by measuring the QBER estimation information by the receiving terminal.

3. The method of claim 2, wherein the error correction information includes (i) information for the bit value of the checking sequence and (ii) information for a basis used for a polarization coding for a bit at a specific location in a bit string of the checking sequence.

4. The method of claim 3, wherein based on (a) (i) the basis used for the polarization coding for the bit at the specific location in the bit string of the checking sequence at the transmitting terminal and (ii) a basis at the receiving terminal used for measuring the QBER estimation information corresponding to the specific location in the bit string of the checking sequence at the transmitting terminal being the same, and (b) (i) a bit value of the bit at the specific location and (ii) a measurement value of the QBER estimation information corresponding to the specific location being different; the measurement value at the receiving terminal of the QBER estimation information corresponding to the specific location is corrected to the same value as the bit value of the bit at the specific location based on the error correction information.

5. The method of claim 1, wherein an authentication message for the authentication is generated based on (i) the reused checking sequence and (ii) the pre-shared symmetric key.

6. The method of claim 5, wherein the pre-shared symmetric key is used to determine a location of bits used to generate the authentication message in a bit string of the reused checking sequence.

7. The method of claim 6, wherein a length of a bit string of the pre-shared symmetric key and a length of a bit string constituting the reused checking sequence are the same.

8. The method of claim 7, wherein at least one bit in the bit string of the reused checking sequence which is at a location corresponding to a location of at least one bit with a specific bit value in the bit string of the pre-shared symmetric key is the authentication message.

9. The method of claim 6, wherein, based on a bit value at a first location of the bit string of the pre-shared symmetric key, bit values of odd positions or bit values of even positions in the bit string of the reused checking sequence are used to generate the authentication message.

10. The method of claim 9, wherein the authentication message is generated based on a XOR operation on (i) the pre-shared symmetric key and (ii) bit values of odd positions or bit values of even positions in a bit string of a checking sequence.

11. The method of claim 10, wherein based on the bit values of the odd positions in the bit string of the checking sequence being used to generate the authentication message, bit values of odd positions of the pre-shared symmetric key are used for the XOR operation, and
wherein based on the bit values of the even positions in the bit string of the checking sequence being used to generate the authentication message, bit values of even positions of the pre-shared symmetric key are used for the XOR operation.

12. The method of claim 5, wherein the pre-shared symmetric key is used to select a hash function for generating the authentication message.

13. The method of claim 12, wherein the reused checking sequence is used as an input of the hash function mapped to a bit value of the pre-shared symmetric key, and
wherein an output value of the hash function mapped to the bit value of the pre-shared symmetric key is the authentication message.

14. The method of claim 1, further comprising:
transmitting, by the transmitting terminal to the receiving terminal, message information on the quantum channel based on a result of the authentication; and
updating, by the transmitting terminal, the pre-shared symmetric key based on (i) the message information and (ii) the pre-shared symmetric key.

15. The method of claim 14, wherein the pre-shared symmetric key is updated based on an XOR operation on (i) the message information and (ii) the pre-shared symmetric key.

16. A transmitting terminal comprising:
a transmitter transmitting a radio signal;
a receiver receiving the radio signal;
at least one processor; and
at least one computer memory operably connectable to the at least one processor and storing instructions performing operations based on being executed by the at least one processor,
wherein the operations comprise:
transmitting, to a receiving terminal, quantum bit error rate (QBER) estimation information generated based on a checking sequence for QBER estimation for detecting an eavesdropping on a quantum channel;
performing the QBER estimation with the receiving terminal based on the QBER estimation information; and
performing an authentication with the receiving terminal by reusing the checking sequence, based on a result of the QBER estimation,
wherein the authentication is performed based on (i) the reused checking sequence and (ii) a pre-shared symmetric key between the transmitting terminal and the receiving terminal.

17. (canceled)

18. A receiving terminal comprising:
a transmitter transmitting a radio signal;
a receiver receiving the radio signal;
at least one processor; and
at least one computer memory operably connectable to the at least one processor and storing instructions performing operations based on being executed by the at least one processor,
wherein the operations comprise:
receiving, from a transmitting terminal, quantum bit error rate (QBER) estimation information generated based on a checking sequence for QBER estimation for detecting an eavesdropping on a quantum channel;
performing the QBER estimation with the transmitting terminal based on the QBER estimation information; and
performing an authentication with the transmitting terminal by reusing the checking sequence, based on a result of the QBER estimation,
wherein the authentication is performed based on (i) the reused checking sequence and (ii) a pre-shared symmetric key between the transmitting terminal and the receiving terminal.

19-20. (canceled)
